(19) United States
(12) Patent Application Publication
(10) Pub. No.: US 2026/0189140 A1
(43) Pub. Date: Jul. 2, 2026

(54) CONTROL OF MULTI-LEVEL POWER CONVERTERS AND ASSOCIATED SYSTEMS AND METHODS

(71) Applicant: pSemi Corporation, San Diego, CA (US)

(72) Inventor: Gregory Szczeszynski, Nashua, NH (US)

(21) Appl. No.: 19/457,082

(22) Filed: Jan. 22, 2026

Related U.S. Application Data
(63) Continuation-in-part of application No. 18/607,085, filed on Mar. 15, 2024.
Application No. 18/607,085 is a continuation of application No. 17/560,767, filed on Dec. 23, 2021, now Pat. No. 11,936,291.
(63) Continuation-in-part of application No. PCT/US2025/011265, filed on Jan. 10, 2025.
(60) Provisional application No. 63/276,923, filed on Nov. 8, 2021.
(60) Provisional application No. 63/620,450, filed on Jan. 12, 2024.
(60) Provisional application No. 63/620,469, filed on Jan. 12, 2024.
(60) Provisional application No. 63/748,065, filed on Jan. 22, 2025.

(51) Int. Cl. H02M 3/07; H02M 1/00; H02M 3/158; H02M 7/483

(52) U.S. Cl. CPC H02M 3/07; H02M 3/158; H02M 7/4833; H02M 7/4837; H02M 1/0095

(57) ABSTRACT

Systems, circuits, and methods for controlling multi-level power converters are provided. In one example, a method is disclosed. The method may include providing a supply voltage to a power converter, where the power converter includes a fly capacitor, the power converter is selectively configurable in one of a plurality of states including a charge state of the fly capacitor and a discharge state of the fly capacitor, and a target voltage across the fly capacitor is a fraction of the supply voltage. The method may further include generating a voltage sample of a voltage across the fly capacitor. The method may further include selecting between the charge state and the discharge state based on the voltage sample by selecting the charge state when the target voltage exceeds the voltage sample and the discharge state when voltage sample exceeds the target voltage.

### CROSS-REFERENCE TO RELATED APPLICATIONS

This patent application claims priority to and the benefit of U.S. Provisional Patent Application No. 63/748,065, filed on Jan. 22, 2025 and entitled “CONTROL OF MULTI-LEVEL POWER CONVERTERS AND ASSOCIATED SYSTEMS AND METHODS,” which is incorporated herein by reference in its entirety.

This patent application is a continuation-in-part of U.S. patent application Ser. No. 18/607,085, filed on Mar. 15, 2024 and entitled “CONTROLLING CHARGE-BALANCE AND TRANSIENTS IN A MULTI-LEVEL POWER CONVERTER,” which is a continuation of U.S. patent application Ser. No. 17/560,767, filed on Dec. 23, 2021 and entitled “CONTROLLING CHARGE-BALANCE AND TRANSIENTS IN A MULTI-LEVEL POWER CONVERTER,” issued on Mar. 19, 2024 as U.S. Pat. No. 11,936,291, which claims priority to and the benefit of U.S. Provisional Patent Application No. 63/276,923, filed on Nov. 8, 2021 and entitled “CONTROLLING CHARGE-BALANCE AND TRANSIENTS IN A MULTI-LEVEL POWER CONVERTER,” all of which are incorporated herein by reference in their entirety.

This patent application is a continuation-in-part of International Patent Application No. PCT/US2025/011265 filed Jan. 10, 2025 and entitled “CAPACITOR SENSING AND CAPACITOR BALANCING SYSTEMS AND METHODS,” which claims priority to and the benefit of U.S. Provisional Patent Application No. 63/620,450, filed on Jan. 12, 2024 and entitled “CAPACITOR SENSING AND CAPACITOR BALANCING SYSTEMS AND METHODS,” and U.S. Provisional Patent Application No. 63/620,469, filed on Jan. 12, 2024 and entitled “CAPACITOR SENSING AND CAPACITOR BALANCING SYSTEMS AND METHODS,” all of which are incorporated herein by reference in their entirety.

### BACKGROUND

This disclosure relates to electronic circuits, and more particularly for example to multi-level power converters.

Many electronic products, including mobile computing and/or communication products and components (e.g., notebook computers, ultra-book computers, tablet devices, LCD, LED displays, and the like) use multiple voltage levels for operation. For example, radio frequency (RF) transmitter power amplifiers may operate at relatively high voltages (e.g., 12V or more), whereas logic circuitry may operate at a relatively low voltage level (e.g., 1-3V) and other circuitry may operate at an intermediate voltage level (e.g., 5-10V).

Direct current power converters are often used to generate a lower or higher voltage from a common power source, such as a battery, solar cells, and rectified AC sources. Power converters which generate a lower output voltage level from a higher input voltage power source are commonly known as buck converters, so-called because the output voltage V_{OUT} is less than the input voltage V_{IN}, and hence the converter is “bucking” the input voltage. Power converters which generate a higher output voltage level from a lower input voltage power source are commonly known as boost converters, because V_{OUT} is greater than V_{IN}. Some power converters may be either a buck converter or a boost converter depending on which terminals are used for input and output. Some power converters may provide an inverted output.

One type of direct current power converter known as a multi-level power converter includes charge transfer capacitors as energy storage elements coupled by controlled switches to transfer charge from V_{IN} to V_{OUT}. Such charge transfer capacitors are commonly known as “fly capacitors” or “pump capacitors”. When a fly capacitor is used (i.e., not bypassed), the electrical energy flowing through that fly capacitor generally will either charge it or discharge it.

There is a continued need for improved circuits and methods for more effectively and efficiently operating and implementing multi-level converter circuits.

### SUMMARY

Embodiments of the present disclosure include systems, circuits, and methods for controlling multi-level power converters.

In some aspects, a method is disclosed. In some embodiments, the method includes providing a supply voltage to a power converter, wherein the power converter comprises a fly capacitor, wherein the power converter is selectively configurable in one of a plurality of states comprising a charge state of the fly capacitor and a discharge state of the fly capacitor, and wherein a target voltage across the fly capacitor is a fraction of the supply voltage. The method may further include generating a voltage sample of a voltage across the fly capacitor. The method may further include selecting between the charge state and the discharge state based on the voltage sample by selecting the charge state when the target voltage exceeds the voltage sample and the discharge state when voltage sample exceeds the target voltage.

In some aspects, a system is disclosed. In some embodiments, the system includes a power converter comprising a fly capacitor, wherein the power converter is selectively configurable in one of a plurality of states comprising a charge state of the fly capacitor and a discharge state of the fly capacitor, and wherein the power converter is configured to connect to a supply voltage terminal. The system may further include a sensing circuit configured to compare a measured voltage across the fly capacitor and a target fraction of a voltage supplied to the supply voltage terminal to generate a comparison value. The power converter may be set to the charge state when the comparison value indicates that the measured voltage exceeds the target fraction and may be set to the discharge state when the comparison value indicates that the measured voltage is less than the target fraction.

In some aspects, an integrated circuit is disclosed. In some embodiments, the integrated circuit includes a switchable power conversion network configured to connect to a voltage supply terminal and a capacitor, wherein the switchable power conversion network is switchable among a charging state and a discharging state, wherein in the charging state the switchable power conversion network is set to charge the capacitor, wherein in the discharging state the switchable power conversion network is set discharge the capacitor, wherein the switchable power conversion network is configured to be set to the discharge state when a measured voltage across the capacitor exceeds a target value and set to the charge state otherwise.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### DESCRIPTION OF THE DRAWINGS

FIG. 1A is an example power converter circuit with internal input current sense, in accordance with one or more embodiments of the present disclosure.

FIG. 1B is an example power converter circuit with external input current sense, in accordance with one or more embodiments of the present disclosure.

FIG. 2A is an example dual integrated circuit (IC) power converter circuit with internal input current sense, in accordance with one or more embodiments of the present disclosure.

FIG. 2B is an example dual IC power converter circuit with external input current sense, in accordance with one or more embodiments of the present disclosure.

FIG. 3A is an example functional block diagram of a power converter circuit, in accordance with one or more embodiments of the present disclosure.

FIG. 3B is an example functional block diagram of a power converter circuit, in accordance with one or more embodiments of the present disclosure.

FIG. 4 is a diagram illustrating an example charging function in step down regulation mode of an example power converter circuit, in accordance with one or more embodiments of the present disclosure.

FIG. 5 is a diagram illustrating an example charging function in step down divide by 3 charge pump mode, in accordance with one or more embodiments of the present disclosure.

FIG. 6 is a functional block diagram illustrating aspects of an example power converter circuit, in accordance with one or more embodiments of the present disclosure.

FIG. 7 is a block diagram illustrating an example system implementing a power converter circuit, in accordance with one or more embodiments of the present disclosure.

FIG. 8A is a circuit diagram illustrating an example 3-level converter circuit, in accordance with one or more embodiments of the present disclosure.

FIG. 8B is a circuit diagram illustrating an example 4-level converter circuit, in accordance with one or more embodiments of the present disclosure.

FIG. 8C is a circuit diagram illustrating an example M-level converter circuit, in accordance with one or more embodiments of the present disclosure.

FIG. 9 is an example M-level converter circuit, in accordance with one or more embodiments of the present disclosure.

FIG. 10 is a block diagram of an example embodiment of control circuitry for an M-level converter cell, in accordance with one or more embodiments of the present disclosure.

FIG. 11A is a circuit diagram illustrating the charge and discharge states of the example 3-level converter circuit, in accordance with one or more embodiments of the present disclosure.

FIG. 11B is a logic table for the power converter circuit presented in FIG. 11A, in accordance with one or more embodiments of the present disclosure.

FIG. 12 illustrates an example multi-level power converter circuit within a system, according to some aspects of the disclosure.

FIG. 13 illustrates an example embodiment of a sensing circuit, according to some aspects of the disclosure.

FIG. 14 illustrates another example of a sensing circuit, according to some aspects of the disclosure.

FIGS. 15A through 15F illustrate example timing diagrams for controlling a multi-state power converter, according to some aspects of the disclosure.

FIG. 16 illustrates an example of a method of controlling a multi-state power converter, according to some aspects of the disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The present disclosure encompasses novel circuits, architectures, systems, and methods that more effectively and efficiently address the configuration and operation of multi-level converter circuits. It will be appreciated that various improvements disclosed herein encompass innovative circuits, hardware components, architectures, and related logic that are applicable to applications beyond multi-level converter circuits.

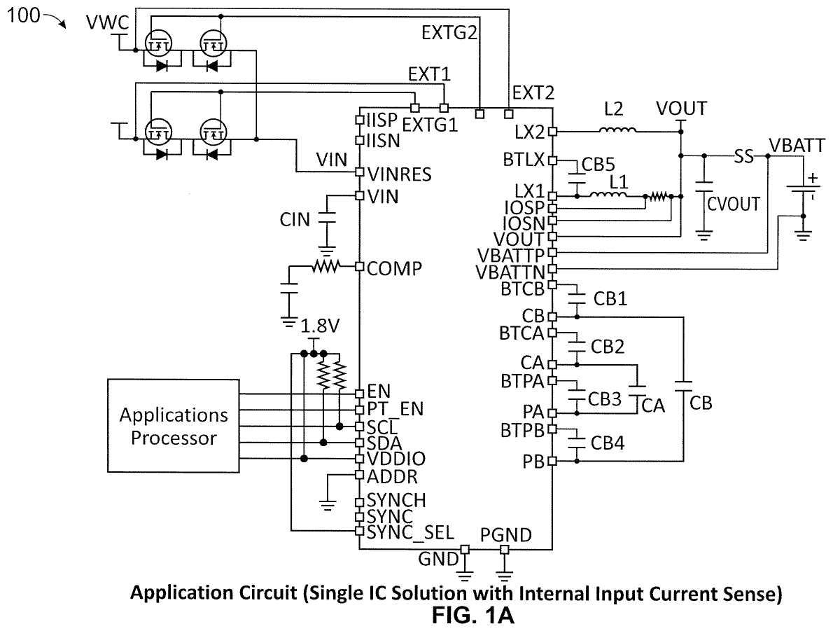

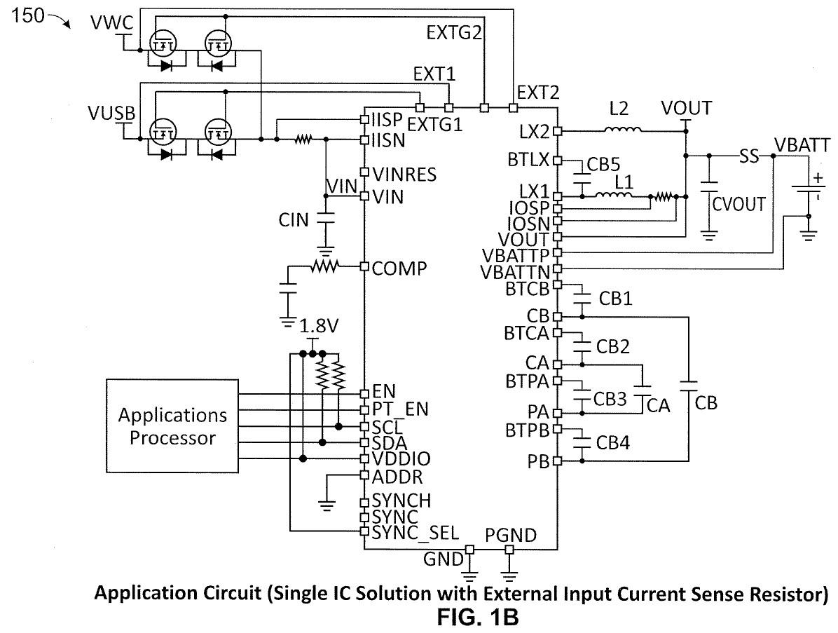

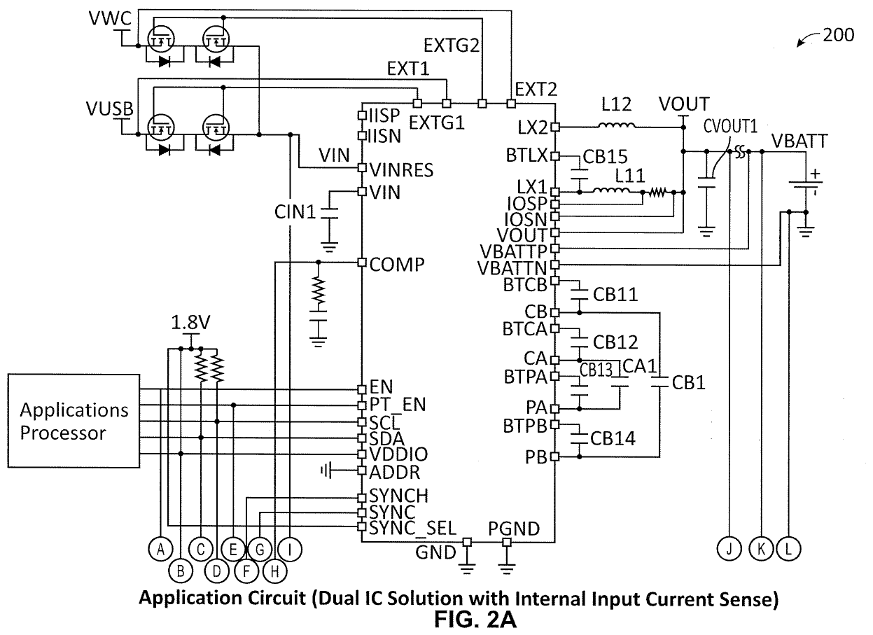

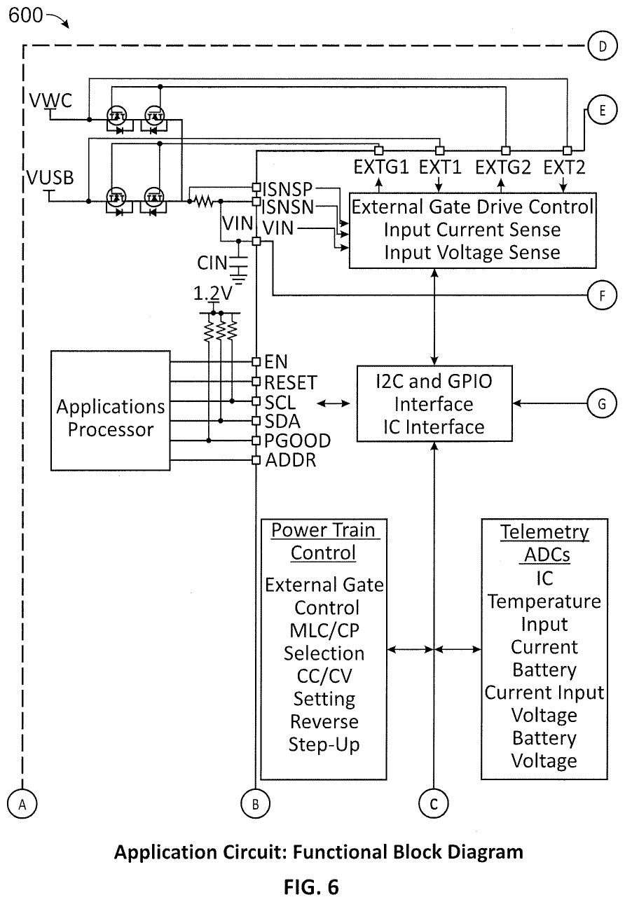

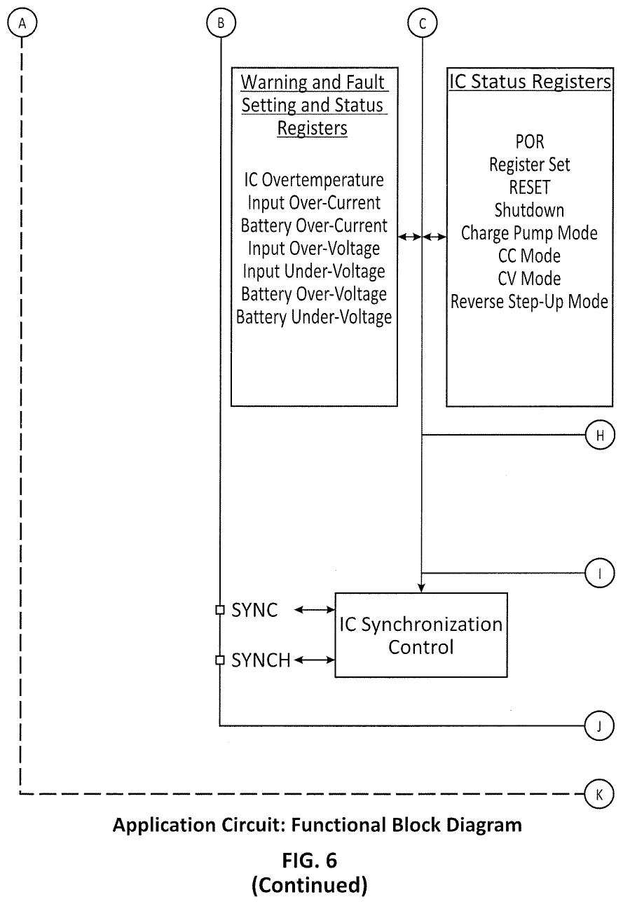

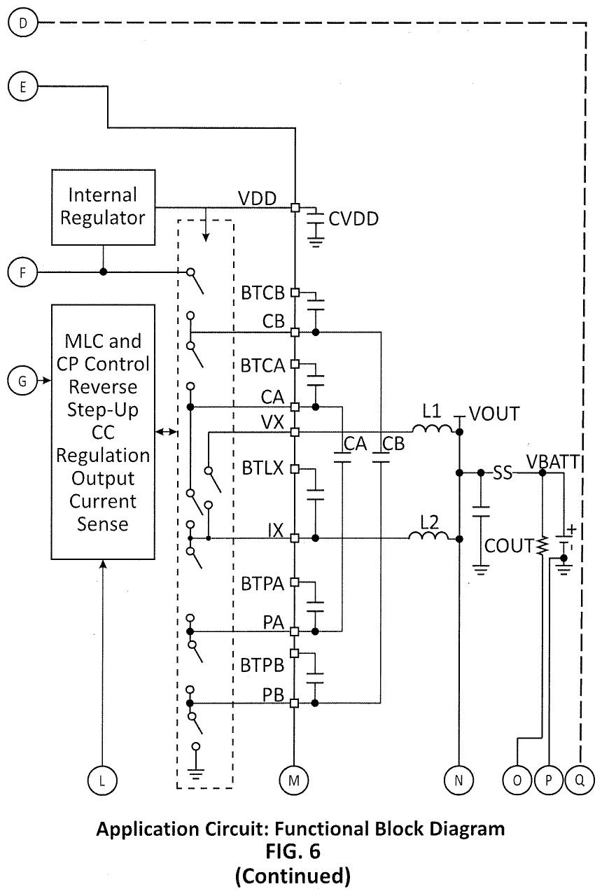

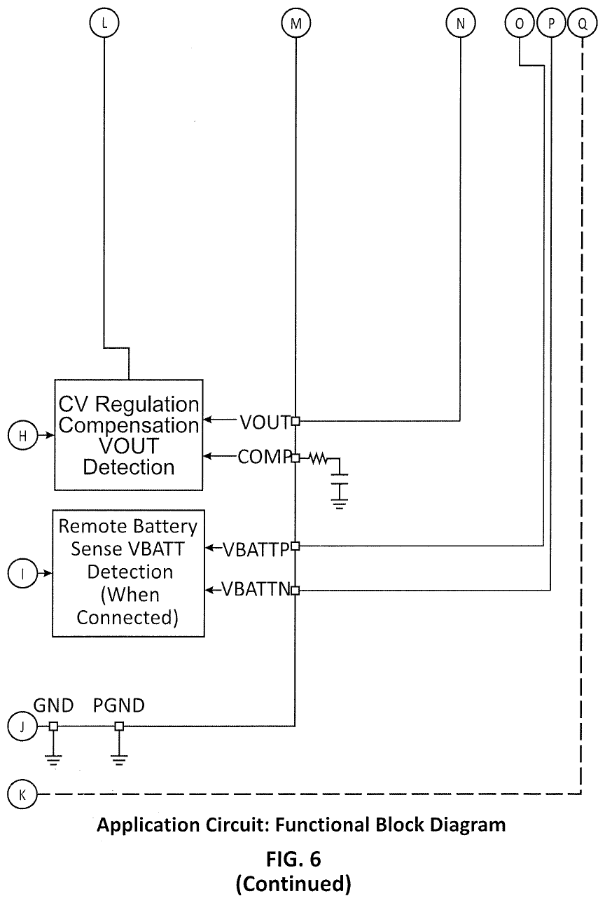

FIGS. 1-6 illustrate various embodiments of a high efficiency 4-level step-down and step-up power converter for battery charging applications, such as single cell Li-ion and Li-polymer battery applications. In the illustrated embodiments, the power converter is configured to deliver up to 5 amperes (A) of charging current in regulation mode and in a divide-by-3 charge pump mode, though other configurations are within the scope of the present disclosure. The power converter can be configured, for example, into dual ICs operation for 9 A charging current in regulation mode and in divide-by-3 charge pump mode. Although a 4-level power converter is illustrated, it will be appreciated that the embodiments described herein may be applicable to various M-level implementations, where M>=3.

In some implementations, for example, the power converter may supply an input range of approximately 4.5 V to 18 V input to support both universal serial bus (USB) and wireless inputs, and in a reverse step-up mode, the output may be programmable from 4.8 V to 16 V in 100 mV step with a programmable output current limit up to 1.7 A. This input voltage range may be used, for example, to support fast charging of single Li-Ion cells from USB and wireless input. It will be appreciated that other voltage and current ranges and limits may be implemented depending on the application. It will also be appreciated that while compatibility with USB is described herein, other wired interfaces and protocols may be implemented with the power converter of the present disclosure.

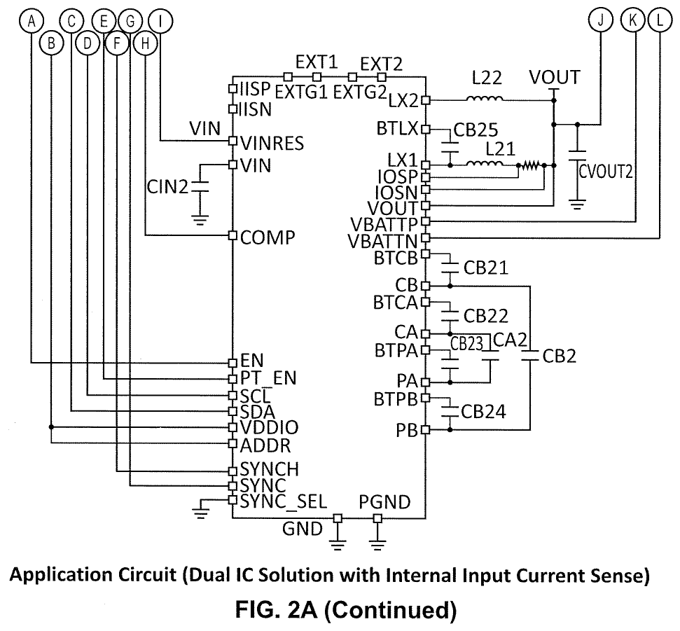

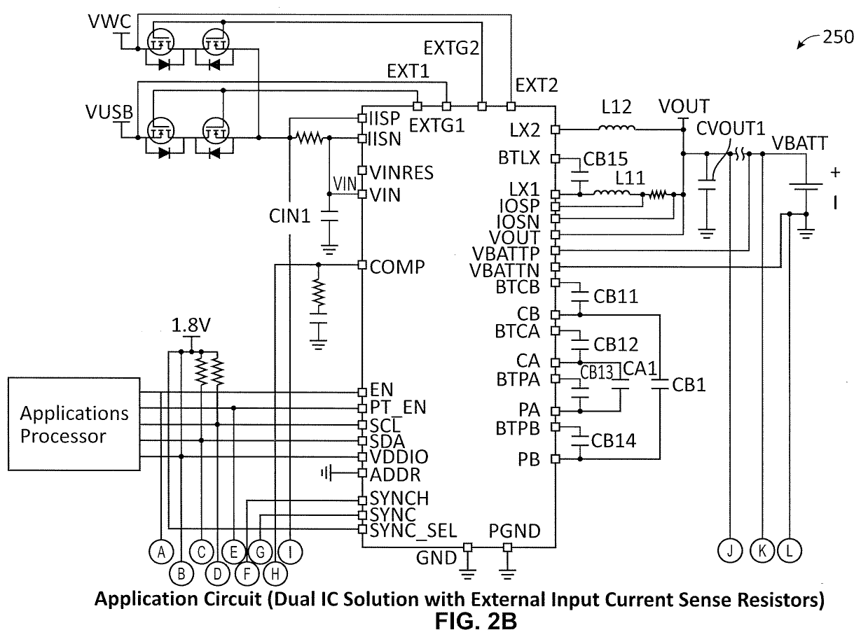

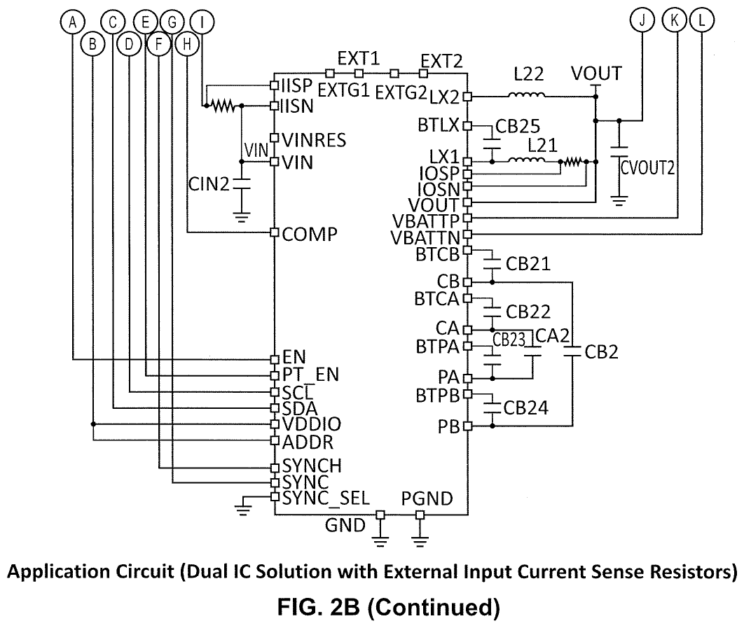

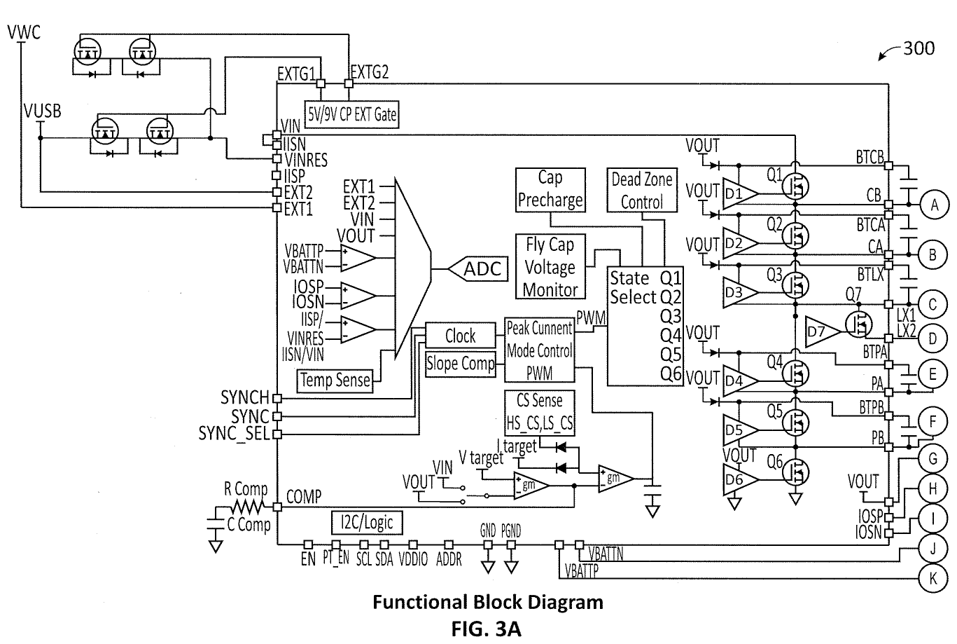

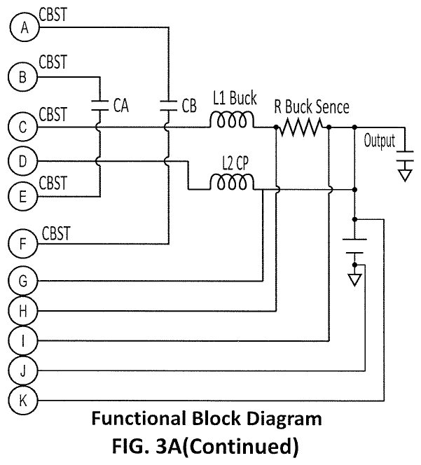

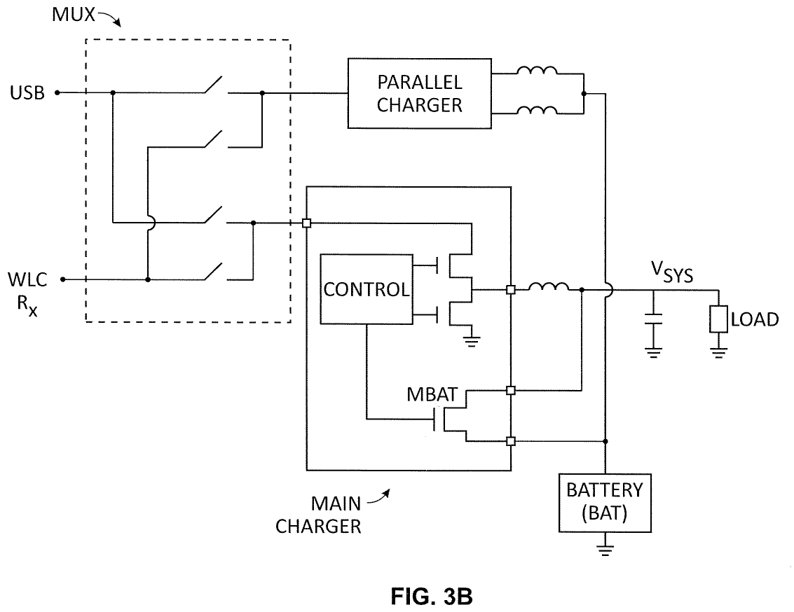

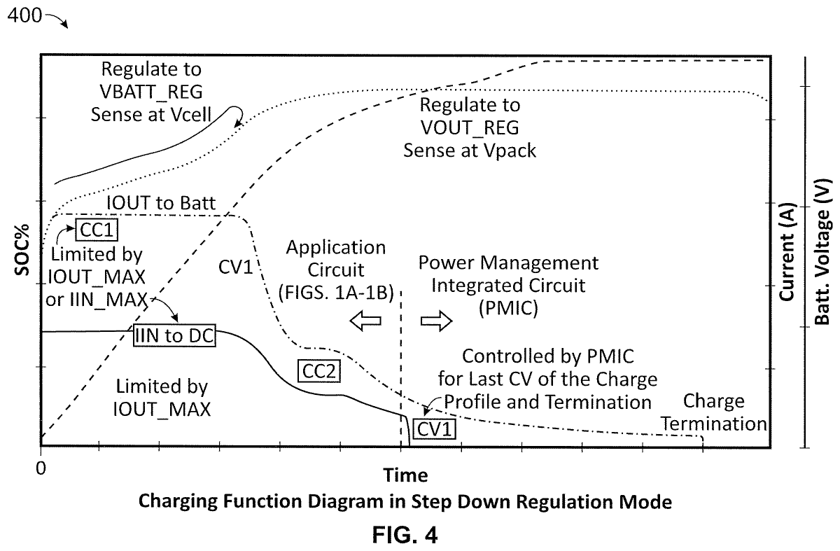

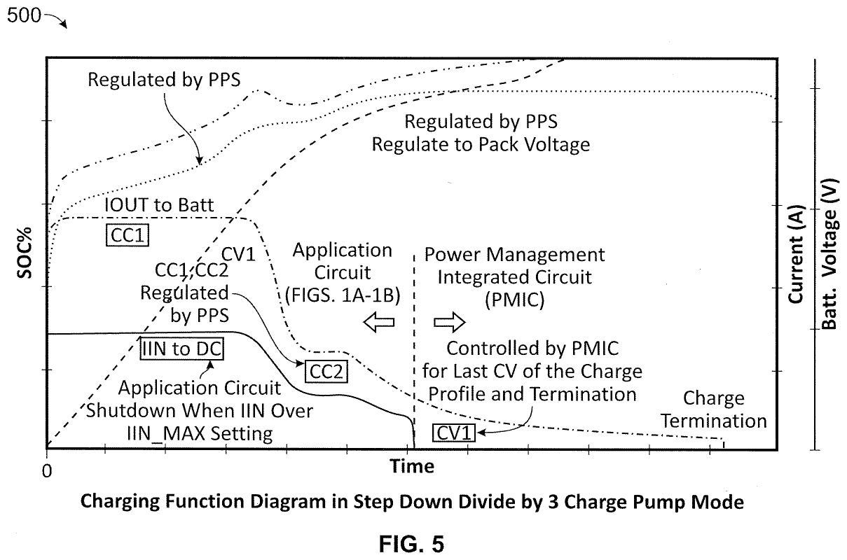

In various embodiments, the power converter may be implemented as a single integrated circuit (IC) (see, e.g., FIGS. 1A-B), dual-integrated circuits (see, e.g., FIGS. 2A-B), or in other configurations depending on the implementation. In various embodiments, the power converter may operate as a parallel charger along with a main charger, as shown in FIG. 3B, to provide the desired functionality noted herein and, for example, as illustrated in FIGS. 4 and 5 for the desired charging functionality for various applications, as would be understood by one skilled in the art. FIG. 3B may represent a system level point of view of a mobile architecture having a parallel charger and a main charger that accepts power from a wired port (e.g., a wired USB) or from a wireless interface. The parallel charger for one or more embodiments may represent an IC as illustrated in FIGS. 1-3A, for example, and may function to charge a battery for some portion of the charging profile (e.g., as shown in FIGS. 4 and 5), while the main charger charges the battery for other portions of the charging profile. In various embodiments, the parallel charger may also be configured to function as the main charger as well, depending upon the desired application. The novel architecture disclosed herein may be implemented to enable (i) improved efficiency (e.g., at 9 A charging current) in a low-profile solution; (ii) low electromagnetic interference (EMI) fixed-frequency operation under heavy load conditions; (iii) input and output current and voltage, IC temperature monitoring and telemetry via inter-integrated circuit (I₂C) technology; and/or (iv) full protection including input and output under voltage lockout (UVLO), input and output over voltage protection (OVP), input and output over current protection (OCP), and IC over-temperature with fault and warning status. In some implementations, the power converter supports divide-by-3, step-down and step-up regulating modes, dual external disconnect switch control, and/or paralleled operation.

In the illustrated embodiments, the power converter is implemented as a multi-level charge pump incorporating power switches and control circuitry. The power converter's internal bias may be provided by the system battery through a VOUT connection (e.g., pin). The charging input can be USB (or other wired input) or wireless input by an external FET register control. In some implementations, the power converter may be programmed to different operating modes, which may include a step-down regulation mode, a step-down divide-by-3 charge pump mode, and a reverse step-up mode.

In a step-down regulation mode, the power converter operates as a multi-level step-down regulator to support USB power delivery (USB-PD) (or other wired protocol) or fixed input charging. During a constant-current (CC) phase, the maximum charging current may be limited for example, by configuring registers. When the input current does not reach a predetermined maximum input setting, the charge current is set to a predetermined maximum output setting. If the input current reaches the input maximum setting, then the charge current throttles and maintains input current at the input maximum setting. This allows maximum charging current while ensuring that the charge current does not go above a battery maximum current rating and the input current does not trip adapter over-current protection.

During a constant-voltage (CV) phase, the CV regulation may be limited, for example, by configuring registers. In operation, a single-wire sense pin or other sensor is configured to sense the output voltage VOUT, which is compared to a predetermined value stored in a register, VOUT_REG. The voltage differential between the battery's positive terminal and negative terminal is sensed and compared to a predetermined value stored in a register, VBATT_REG. In some implementations, a single-wire sense pin or other sensor senses VBATTP (battery voltage at positive terminal) and a single-wire sense pin or other sensor senses VBATTN (battery volage at negative terminal). The CV regulates to the lower of the two settings. If the VOUT sensed voltage reaches VOUT_REG first, then CV is regulated to VOUT_REG. If the VBATTP sensed voltage reaches VBATT_REG first, then CV is regulated to VBATT_REG. This provides a fast battery top off while preventing voltage above safety limit.

In a step-down divide-by-3 charge pump mode (which may be selected, for example, by setting a corresponding register), the power converter is configured as a divide-by-3 step-down charge divider to support USB-Programmable Power Supply (USB-PPS) or other charging protocol or programmable input charging. In some embodiments, the power converter allows the USB-PPS adapter to control voltage and current and ignores conflicting settings (e.g., settings stored in registers for IOUT_MAX, VOUT_REG and VBATT_REG). In this mode, the power converter monitors an IIN_MAX setting, shuts down the power train (which includes switches to configure, enable and disable various modes of operation) and disconnects external FET when IIN current exceeds IIN_MAX setting. In the illustrated embodiment, the output current is up to 10 A in dual IC operation and 5 A in single IC operation.

In a reverse step-up mode (which may be selected, for example, by setting a corresponding register) the power converter is configured as a multi-level step-up regulator to power peripheral device(s) connected to USB (or other wired protocol or standard) or wireless input. The power converter draws power from the system battery and regulates VIN to the VOUT_REG programmable setting of 4.8V to 16V. The VIN output current limit may be set, for example, by an IIN_MAX register.

In some embodiments, to enable the IC, both an EN pin and an IC_EN bit are set to logic high (1). When either the EN pin or IC_EN bit is set to logic low (0), the IC is disabled. After the IC is enabled, the POR status bit sets to 1 to indicate the IC has a fresh power up.

In some embodiments, the power converter provides a gate driver to control two external N-channel MOSFETs and sense inputs to monitor source input voltage at each FET. The external FETs may be controlled by registers (e.g., 1-bit registers V_EXTG, EXTG_EN and EXTGX). The V_EXTG bit sets the gate drive voltage and can be set to 9V or 5V, in the illustrated embodiment. The EXTGX bits select which FET(s) to turn on. The EXTG_EN bit enables the gate driver to turn on the selected FET(s). In various embodiments, the external FET can be turned on or off independently from other IC operations except when the IC is disabled. The EXT_EN_IND status bit set to 1 when external FET is enabled. When a fault is detected and triggers a shutdown, the external FET may be turned off automatically. If EXT1 or EXT2 detects an OVP, then the respected FET would not turn on from the off mode.

In various embodiments, the power train is enabled after all the registers have been initialized and the target input external FET is turned on. Sufficient time based on capacitance on the power path may be configured between the external FET on time and the power train on time to minimize in-rush current. Next, both PT_EN pin and PT_EN bit are set to logic high (1) to turn on the power train. When either PT_EN pin or PT_EN pin is logic low, the power train is off. In dual IC operation, the slave IC power train may be configured to turn on first before the master IC. The COMP, SYNC and SYNCH pins from two ICs gate the power train and synchronize the operation. The SYNC_SEL pin sets the IC to master mode or slave mode. IC internal fault and programmable fault detection shuts down the power train operation when fault is detected.

In a reverse step-up mode (which may be selected, for example, by setting a corresponding register), the power converter is configured as a multi-level step-up regulator to power peripheral device(s) connected to USB (or other wired port) or wireless input. The power converter draws power from the system battery and regulates VIN pin to a VOUT_REG programmable setting of 4.8V to 16V. The VIN output current limit is set by IIN_MAX register.

To enable the IC, both the EN pin and IC_EN bit are set to logic high (1). When either EN pin or IC_EN bit is set to logic low (0), the IC is disabled. After the IC enables, the POR status bit sets to 1 to indicate the IC has a fresh power up. The power converter provides a gate driver to control two external N-channel MOSFETs and sense inputs to monitor source input voltage at each FET. The external FETs are controlled by register bits, such as V_EXTG, EXTG_EN and EXTGX. The V_EXTG bit sets the gate drive voltage and can be set to 9V or 5V, for example. The EXTGX bits select which FET(s) to turn on. The EXTG_EN bit enables the gate driver to turn on the selected FET(s). The external FET can be turned on or off independently from other IC operation except when the IC is disabled. The EXT_EN_IND status bit set to 1 when external FET is enabled.

When a fault is detected and triggers a shutdown, the external FET may be turned off automatically. If EXT1 or EXT2 detects an OVP, then the respective FET would not turn on from off mode. The power train is enabled after all the registers have been initialized and the target input external FET is turned on. Sufficient time based on capacitance on the power path should be given between external FET on time to power train on time to minimize in-rush current. Next, both PT_EN pin and PT_EN bit are set to logic high (1) to turn on the power train. When either PT_EN pin or PT_EN pin is logic low, the power train is off. In dual IC operation, the slave IC power train is turned on before the master IC. The COMP, SYNC and SYNCH pins from the two ICs gate the power train and synchronize the operation. SYNC_SEL pin sets the IC to master mode or slave mode. IC internal fault and programmable fault detection shuts down power train operation when a fault is detected.

In accordance with various embodiments, an example power converter initialization, an example power up sequence, and an example fault handling will now be described for the three different operating modes. In an example step-down regulation mode, the initialization and power up sequence uses EXT1 as an example. The same sequence may apply to EXT2 with the only change in EXTGX bit and related EXT2 register settings. First, pull EN to logic high and then set IC_EN bit=1 at 100 us(TBD) after EN is logic high to enable IC. IC startup from POR stage, POR bit reports 1 indicating fresh IC startup. Next, the POR bit is read to confirm the IC is enabled. The FREQUENCY register is then set to a desired setting. In dual IC operation, both ICs are set to the same frequency setting. The VOUT_REG register is set to the target regulation voltage on the VOUT sense pin in CV operation. The VBATT_REG register is set to the target regulation voltage on the VBATTP sense pin in CV operation. The IOUT_MAX register is set to the target maximum charger current in CC operation, and the IIN_MAX register is set to a value below the adapter current limit. Next, the FAULT and WARNING registers was set to a desired setting. Each Fault and Warning enables at a different time based on IC status and operating mode. The WATCHDOG register is then set to a desired setting.

The MODE register and other related registers are set for step-down regulation mode, including power train setup and enablement of an external FET, while checking for faults. In a dual IC operation, the external FETs are controlled by the master IC. If a fault (e.g., OVP event) is detected, then a shutdown register may be set to “1” to indicate a fault shutdown event and a sequence to enable the external FET after the shutdown fault is initiated. Next, the power train is enabled. In a dual IC operation, the slave IC power train is turned on before the master IC. After the power train is enabled, a bit may be set to indicate that the power train is ready and charging the battery. In some embodiments, a watchdog timer may be set to periodically check the IC status during charging operation.

If a fault event is detected, then the IC determines which faults events were triggered, such as the power train may be set to enable but it is off due to fault(s), an external FET is set to enable but the FET is off due to fault(s). The shutdown procedure may include resetting register values and repeating setup steps of enabling the power train, external FET, or other component that is disabled due to a fault.

An example step-down divide-by-3 power converter mode initialization and power up sequence will now be described. The initialization and power up sequence uses EXT1 as an example, but it will be appreciated that the same sequence applies to EXT2 with a change in EXTGX bit and related EXT2 register settings. The EN is pulled to logic high and then IC_EN bit=1 at 100 us(TBD) after EN is logic high to enable IC. The IC starts up from POR stage, POR bit reports 1 indicating fresh IC startup. The POR bit is read to confirm the IC is enabled. The FREQUENCY register is set to a desired setting. In dual IC operation, both ICs are set to the same frequency setting. The IIN_MAX register is set to a value below the adapter current limit. VOUT_REG, VBATT_REG and IOUT_MAX registers are not used in step-down divide-by-3 charge pump mode. Voltage and current regulation in step-down divide-by-3 charge pump mode may be controlled by the PPS adapter. The FAULT, WARNING, and WATCHDOG registers are set to desired settings. Each Fault and Warning enables at different time based on IC status and operating mode.

The MODE register and other registers are set for step-down divide-by-three mode, including power train setup and external FET setup, while checking for faults. If a fault (e.g., OVP event) is detected, then a shutdown register may be set to “1” to indicate a fault shutdown event and a sequence to enable the power train or external FET, as appropriate, after the shutdown fault is initiated. Next, the power train is enabled. After the power train is enabled, a bit may be set to indicate that the power train is ready and charging the battery. In some embodiments, a watchdog timer may be set to periodically check the IC status during charging operation. Voltage and current regulation in step-down divide-by-3 charge pump mode may be controlled by the PPS adapter.

If a fault event is detected, then the IC determines which faults events were triggered, such as the power train may be set to enable but it is off due to fault(s), or an external FET is set to enable but the FET is off due to fault(s). The shutdown procedure may include resetting register values and repeating setup steps of enabling the power train, external FET, or other component that is disabled due to a fault.

An example reverse step-up mode initialization and power up sequence will now be described. This initialization and power up sequence uses EXT2 as an example, but the same sequence applies to EXT1 with the change in EXTGX bit and related EXT1 register setting. The value EN is pulled to logic high and then IC_EN bit is set to 1 at 100 us(TBD) after EN is logic high to enable IC. The IC starts up from the POR stage, and the POR bit reports 1 indicating a fresh IC startup. The POR bit is read to confirm the IC is enabled. Next, the FREQUENCY register is set to a desired setting. In dual IC operation, both ICs are set to the same frequency setting. The VOUT_REG register is set to the target regulation voltage at VIN. Next, the IIN_MAX register is set to the target current limit. VBATT_REG and IOUT_MAX registers are not used in reverse step-up mode. FAULT, WARNING, and WATCHDOG registers are set to desired settings. Each Fault and Warning enables at a different time based on IC status and operating mode.

The MODE register and other registers are set for reverse step-up mode, including power train setup and external FET setup, while checking for faults. If a fault (e.g., OVP event) is detected, then a shutdown register may be set to “1” to indicate a fault shutdown event and a sequence to enable the power train or external FET, as appropriate, after the shutdown fault is initiated. Next, the power train is enabled. After the power train is enabled, a bit may be set to indicate that the power train is ready and charging the battery. In some embodiments, a watchdog timer may be set to periodically check the IC status during charging operation. Voltage and current regulation in step-down divide-by-3 charge pump mode may be controlled by the PPS adapter. In dual IC operation, the slave IC power train is turned on before the master IC and is controlled by the master IC.

If a fault event is detected, then the IC determines which faults events were triggered, such as the power train may be set to enable but it is off due to fault(s), or an external FET is set to enable but the FET is off due to fault(s). The shutdown procedure may include resetting register values and repeating setup steps of enabling the power train, external FET, or other component that is disabled due to a fault. The EXT2 or VIN pins are not configured to detect OVP as it is set as the output in reverse step-up mode. But if EXT2 or VIN pin detects an OVP event, then IC_STATUS1 and IC_STATUS2 would report the fault event.

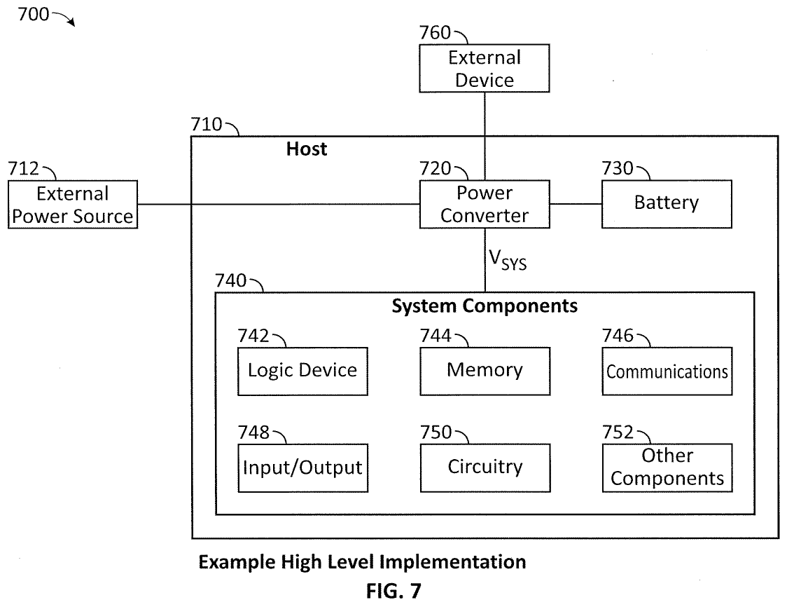

In an example system 700 illustrated in FIG. 7, a power converter 720 is implemented in a host 710 (e.g., a device or system) that includes a battery 730 and various system components 740. The host 710 may be any system or device that implements a power converter as described herein, including but not limited to a smart phone, tablet, portable electronics, a mobile device, low power electronics, and other electronic systems. The battery 730 may include one or more batteries that store electricity for use by the host 710, such as single cell Li-ion and Li-polymer batteries.

The power converter 720 may be configured to convert electricity stored in the battery 730 to a desired system voltage, V_{SYS}, for powering various system components 740, which may include one or more logic devices 742, memories 744, communications components 746, input/output (I/O) components 748, circuitry 750, and other components 752. The power converter 720 may also supply power to one or more external devices 760, such as a component connected to the host 710 through a wired or wireless connection, such as a USB compatible device. The power converter 720 may also be configured to receive power from an external power source 712 and convert the received power to the battery 730 for storage, or to the system components 740 and/or external device 760, as applicable.

In various embodiments, the one or more logic devices 742 and memories 744 may be configured to perform operations of the host 710. A logic device 742 may be implemented as a general-purpose processor, a digital signal processor (DSP), an application-specific integrated circuit (ASIC), a microcontroller, a programmable logic device (PLD), a field-programmable gate array (FPGA), or other programmable logic device(s). The logic device 742 and other components may be configured through hardwiring, software execution, or a combination of both. In various embodiments, the host 710 includes one or more memory devices designed to retain data, such as software instructions for execution by the logic device. The memory may include volatile and non-volatile memories, such as random-access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drives, or other memory types. The logic device may be configured to execute software instructions residing in the memory, thereby accomplishing method steps and operations.

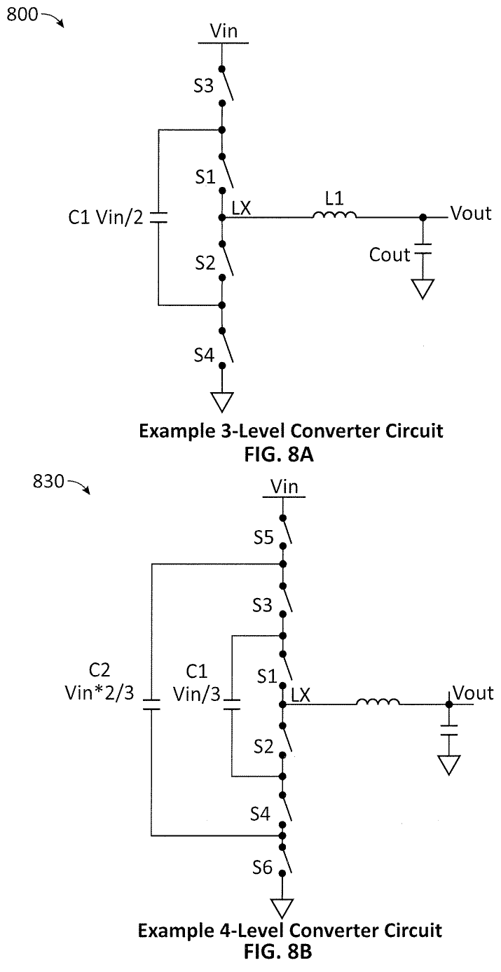

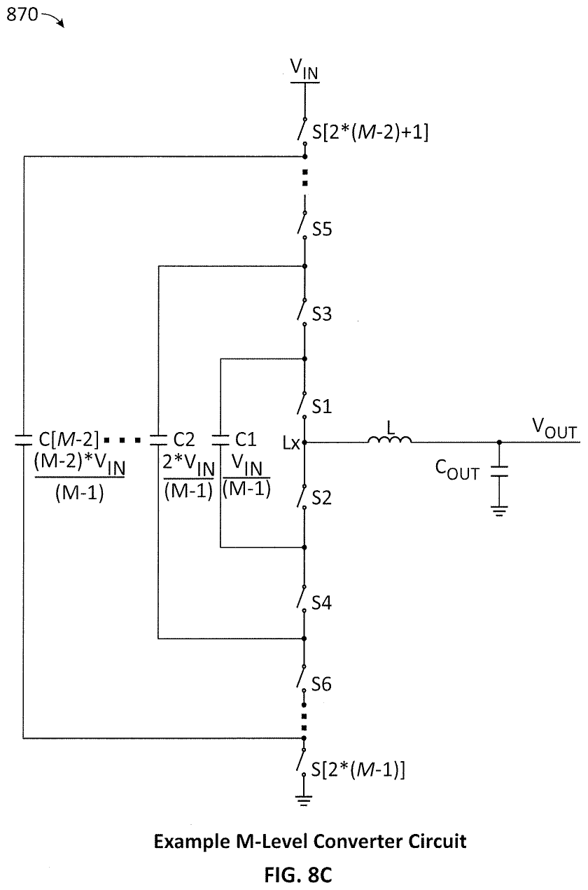

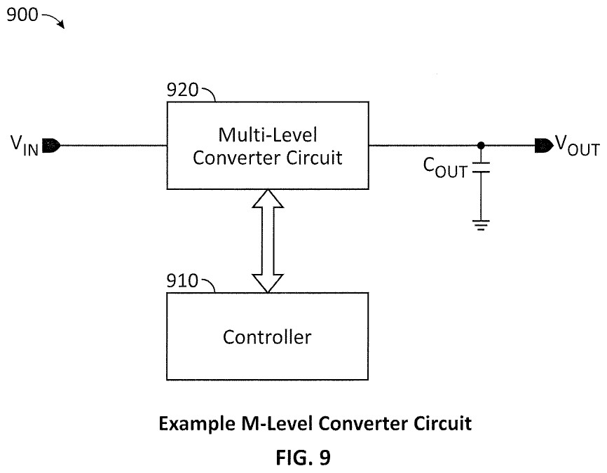

Referring to FIGS. 8A-8C, the converter circuit may be configured to switch between two or more switch states. One or more PWM duty cycle controllers may be provided to set the time in each switch state based on the voltage at VOUT. For example, FIG. 8A is a schematic diagram of a 3-level DC-to-DC buck converter circuit 800 that may be used as the converter circuit 920 of FIG. 9. A set of four switches, S1-S4, is series-coupled between VIN and circuit ground. A fly capacitor C1 is coupled in series with switches S3 and S4, and in parallel with switches S1 and S2. An inductor L1 is coupled to an output capacitor COUT and to a node Lx between switches S1 and S2, and the voltage across the output capacitor COUT is VOUT.

In the illustrated example, the presence of the single fly capacitor C1 in the converter circuit 800 enables four switch states that each generate one of three voltage levels at node Lx. In a first switch state, S2 and S4 are closed and S1 and S3 are open, effectively bypassing C1 and connecting Lx to circuit ground (voltage level at Lx=GND). In a second switch state, S2 and S4 are open and S1 and S3 are closed, effectively bypassing C1 and connecting Lx to V_{IN} (voltage level at Lx=V_{IN}). In a third switch state S1 and S4 are open and S2 and S3 are closed, connecting C1 from V_{IN} to LX, and thus charging C1 with inductor L1 current flowing into a load. The voltage across C1 will be about V_{IN}/2 and the voltage level at Lx will also equal about V_{IN}/2. In a fourth switch state, S1 and S4 are closed and S2 and S3 are open, connecting C1 from Lx to GND and thus discharging C1 with inductor L1 current flowing to a load. The voltage across C1 will be about V_{IN}/2 and the voltage level at Lx will also equal about V_{IN}/2 (e.g., this may assume that C1 was previously charged in state three). Accordingly, the illustrated converter circuit 800 has two switch states that generate a voltage level of V_{IN}/2 at the Lx node.

If the converter circuit 800 is toggled between switch states three and four (avoiding switch state two that bypasses the fly capacitor C1), the inductor L1 sees small jumps in the voltage level at Lx, going from GND to only V_{IN}/2 and back to GND, which results in reduced voltage ripple across the inductor L1 and less filtering to smooth VOUT than a converter circuit with only S1 and S2 switches.

Adding additional series switches Sx and fly capacitors Cx to the 2-level converter circuit 800 increases the number of switch states and resulting voltage levels between VIN and circuit ground that can be applied to the Lx node, thus generating an even smaller voltage ripple across the inductor L. This reduces the filtering requirements to get a smooth output voltage. For example, a 4-level DC-to-DC buck converter circuit (see, e.g., FIG. 8B) includes 6 series-coupled switches S1-S6 and two fly capacitors Cx (X=2). Consequently, a 4-level converter circuit can define 4 voltage levels (VIN, GND, ⅓VIN, and ⅔VIN) at node LX from 8 switch states (3 switch states result in the ⅓VIN level at Lx, and 3 other switch states result in the ⅔VIN level at Lx). For some applications, VOUT is set low enough that the voltage level at node Lx alternates between GND and the next higher voltage level available. For higher output voltages, the switching pattern may never use GND. For example, in a 4-level converter circuit, an output VOUT set to 0.5*VIN can be achieved by alternating the Lx node between ⅔ VIN and 3 V.

A different interpretation of a multi-level converter circuit is that the fly capacitors Cx create a charge-pump for the buck converter circuit. Unlike a standard charge-pump where the output is restricted to one output, a multi-level converter circuit allows the fly capacitors Cx to be coupled to create multiple intermediate voltages. For the 4-level example, the two fly capacitors each act as a 3 charge-pump with the additional benefit that any input voltage that is a sum of ⅓ ratios can be created, including VIN and GND.

A multi-level converter circuit couples the fly capacitors Cx in different combinations in order to bring the voltage level at the Lx node down or up. As noted above, when a fly capacitor is used (i.e., not bypassed), the electrical energy flowing through that fly capacitor generally will either charge it or discharge it, which creates a control problem in maintaining an average voltage.

Resolving the charge-balance problem so as to maintain an average voltage across the single capacitor in a 3-level converter circuit will now be described. For example, in a 3-level converter circuit, one way to generate the Level-1 (GND) and Level-3 (VIN) voltage levels at the Lx node is to not use the fly capacitors C1 for these Lx voltage levels. However, for the Level 2 (VIN/2) voltage level at Lx, two separate switch states can be used: one switch state charges the capacitor (S3 and S2 closed, S1 and S4 open) and the other switch state discharges the capacitor (S3 and S2 open, S1 and S4 closed). The control of a 3-level converter circuit may operate such that each time the converter circuit switches states to Level-2, a controller can alternate between charging and discharging the single capacitor to maintain its voltage. A voltage comparator can be used to monitor the capacitor to help decide on a charging state or a discharging state. For instance, if the capacitor voltage is below VIN/2, then a controller would select charge (the third switch state), and if the capacitor voltage is above VIN/2, then the controller would select discharge (the fourth switch state).

Referring to FIGS. 8B, a 4-level converter circuit 830 (X=2) illustrates the charge-balance difficulty when more capacitors are present. A Level-1 voltage level (GND) and a Level-4 voltage level (VIN) at the Lx node are each determined by a single switch state. However, the Level-2 voltage level (⅓ VIN) and Level-3 voltage level (⅔ VIN) at Lx each can be achieved by any of three different switch states. At higher orders of a multi-level converter circuit (X>2), more switch states are possible for generating the intermediate levels between VIN and GND. The problem gets more complicated with a 5-level converter circuit (X=3). A Level-1 voltage level (GND) and a Level-5 voltage level (VIN) at the Lx node are each determined by a single switch state. However, the Level-2 voltage level (¼ VIN) and Level-4 voltage level (¾ VIN) at Lx each can be achieved by any of four different switch states, the Level-3 voltage level ( 2/4 VIN) at Lx can be achieved by any of six different switch states.

As should be clear from these examples, determining a suitable charge-balance method can become exceedingly difficult as the complexity of a multi-level converter circuit increases. As previously noted, most conventional control methods rely on establishing a sequence of linked state-changes to try to achieve charge balance. Control systems based on long sequences of switch states generally assume that all system variables—such as input voltage and output current—are constant during the sequence. This is unrealistic for a real-world environment, where all system variables tend to be dynamic.

In a 2-Level example, the converter circuit switches between two switch states: S1 closed and S2 open (voltage level at L_{X}=V_{IN}), or S1 open and S2 closed (voltage level at L_{X}=GND). A PWM duty cycle controller sets the time in each switch state based on the voltage at V_{OUT}, which determines the amplitude of the average voltage at L_{X} (noting that, the average L_{X} voltage in theory is equal to the V_{OUT} average voltage, but that, due to parasitics, the L_{X} average voltage is higher and/or lower (for negative currents) than the V_{OUT} average). As can be appreciated, the inductor L sees large jumps in the voltage level at L_{X}, from GND to V_{IN} and back to GND. The resulting voltage ripple across the inductor L necessitates a significant amount of filtering to smooth V_{OUT}.

An alternative way of reducing the voltage ripple across the inductor L is to add more series switches as well as charge transfer capacitors as energy storage elements to transfer charge from V_{IN} to V_{OUT}. As noted above, such charge transfer capacitors are commonly known as “fly capacitors” or “pump capacitors” and may be external components coupled to an integrated circuit embodiment of a converter circuit. The presence of X fly capacitors Cx defines a multi-level capacitive converter circuit capable of generating M=X+2 voltage levels at node L_{X} from 2^{(X+1)} switch states.

FIG. 8C is schematic diagram of a generalized M-level multi-level converter cell 870 that may be used as the converter circuit 920 of FIG. 9. A set of switches, S1-S[2*(M−1)], is series-coupled between V_{IN} and circuit ground. The set of switches are organized in switch pairs: S1 & S2, S3 & S4, . . . S[2*(M−2)+1] & S[2*(M−1)]. A set of M−2 fly capacitor Cx is coupled in series with certain respective switches, and in parallel with switches in between those switches. In terms of switch pairs, there are M−1 pairs of switches, or one more than the number of fly capacitors. An optional inductor L is coupled to an output capacitor C_{OUT} and to a node L_{X} between switches S1 and S2, and again the voltage across the output capacitor C_{OUT} is V_{OUT}. The inductor L doubles as a virtual current source that facilitates movement of charge between the fly capacitors Cx. This creates a very efficient form of charge transfer, but introduces the problem of charge-balancing the fly capacitors Cx.

In various embodiments, each fly capacitor Cx has a first terminal coupled between an outer high-side switch S[2*x+1] and an inner high-side switch S[2*x−1], where “high-side” refers to the V_{IN} side of the converter circuit. Each fly capacitor Cx has a second terminal coupled between an outer low-side switch S[2*x+2] and an inner low-side switch S[2*x], where “low-side” refers to the circuit ground (GND) side of the converter circuit. Thus, for an M=3 multi-level converter cell, a first terminal of the single (X=1) fly capacitor C1 would be coupled between outer high-side switch S3 and inner high-side switch S1, and a second terminal of the capacitor C1 would be coupled between inner low-side switch S2 and outer low-side switch S4. Accordingly, each fly capacitor Cx within the multi-level converter cell 870 has four switches that can affect current flow through that fly capacitor Cx.

In some embodiments, a voltage detector, which may be a simple comparator-type circuit, is provided to sense the voltage across a corresponding fly capacitor Cx with respect to a reference voltage, V_{REF}, which represents a desired target voltage for the fly capacitor Cx. Every fly capacitor Cx may have a target average voltage in order to maintain proper output level. For an M-level converter and capacitor Cx, where x=1, 2, . . . [M−2], its target voltage is:

$$Vtarget [ Cx ] = {V}_{IN} * \frac{x}{M - 1}$$

The voltage detector may be configured to output a HIGH/LOW status signal, C_{Fx_H/L}, indicating with the voltage across the corresponding fly capacitor Cx is greater than V_{REF} or less than V_{REF}. The C_{Fx_H/L} status signal is coupled to control circuitry for the switches associated with the fly capacitor Cx.

The control circuitry for the four switches that can affect current flow through a fly capacitor Cx set states for those switches in part as a function of the voltage across the fly capacitor Cx as measured by the associated voltage detector and conveyed by the C_{Fx_H/L}x status signal. Accordingly, for ease of understanding, it can be said that each fly capacitor Cx “controls” its own pairs of high-side and low-side switches. If it is assumed that current flow in the inductor is charging the output V_{OUT}, there are four possible states that can be defined for the pairs of high-side and low-side switches for each fly capacitor Cx.

In a switch state in which the outer high-side and inner low-side switches associated with fly capacitor Cx are closed and all other associated switches are open, fly capacitor Cx would be in a charging configuration (whether or not charging actually occurs may depend on the switch states for other fly capacitors Cx). In a switch state in which the inner high-side and outer low-side switches associated with fly capacitor Cx are closed and all other associated switches are open, fly capacitor Cx would be in a discharging configuration (whether or not discharging actually occurs may depend on the switch states for other fly capacitors Cx). In a switching state in which the inner low-side and outer low-side switches associated with fly capacitor Cx are closed and all other associated switches are open, fly capacitor Cx would be bypassed. In a switching state in which the outer high-side and inner high-side switches associated with fly capacitor Cx are closed and all other associated switches are open, fly capacitor Cx would again be bypassed.

While each fly capacitor Cx can control both of its own pairs of high-side and low-side switches, in general, methods of control disclosed herein may utilize either the outer switches or the inner switches controllable by each corresponding capacitor. For example, referring to FIG. 8B, in “outer-switch” methods, fly capacitor C1 will control its outer switches S3 and S4, fly capacitor C2 will control its outer switches S5 and S6, etc. Conversely, for example, in “inner-switch” methods, fly capacitor C1 will control its inner switches S1 and S2, fly capacitor C2 will control its inner switches S3 and S4, etc. The switch states of either pair (inner or outer) of switches controlled by a fly capacitor Cx may be complementary—that is, no fly capacitor Cx closes or opens both of its high-side and low-side controlled switches at the same time. If each fly capacitor Cx controls its outer-switches, then no fly capacitor controls the left-over innermost switches S1 and S2. If instead each fly capacitor Cx controls its inner-switches, then no fly capacitor controls the left-over outermost switches S[2*(M−1)] and S[2*(M−2)+1]. Switch states for the left-over switches are also complementary.

FIG. 9 is a high-level block diagram of an example circuit that includes a power converter 900, in accordance with one or more embodiments of the present disclosure. In the illustrated example, the power converter 900 includes a converter circuit 920 and a controller 910. The converter circuit 920 and controller 910 may be configured to implement, for example, any of the multi-level power converter circuits as previously described with reference to FIGS. 1A-8C, and as described further herein. In the illustrated embodiment, the converter circuit 920 is configured to receive an input voltage VIN from a voltage source and transform the input voltage VIN into an output voltage VOUT. In some embodiments of the power converter 900, auxiliary circuitry (not shown), such as a bias voltage generator(s), a clock generator, a voltage control circuit, etc., may also be present and coupled to the converter circuit 920 and the controller 910.

The controller 910 receives a set of input signals and produces a set of output signals. Some of these input signals arrive along a signal path connected to the converter circuit 920. These input signals carry information that is indicative of the operational state of the converter circuit 920. The controller 910 may also receive a clock signal CLK (for synchronous converter circuits 920) and one or more external input/output signals I/O that may be analog, digital (encoded or direct signal lines), or a combination of both. Based upon the received input signals, the controller 910 produces a set of control signals back to the converter circuit 920 that control the internal components of the converter circuit 920 (e.g., internal switches, such as low voltage FETs/MOSFETs) to cause the converter circuit 920 to boost or buck VIN to VOUT. In some embodiments, an auxiliary circuit (not shown) may provide various signals to the controller 910 (and optionally directly to the converter circuit 920), such as the clock signal CLK, the input/output signals I/O, as well as various voltages, such as a general supply voltage VDD and a transistor bias voltage VBIAS.

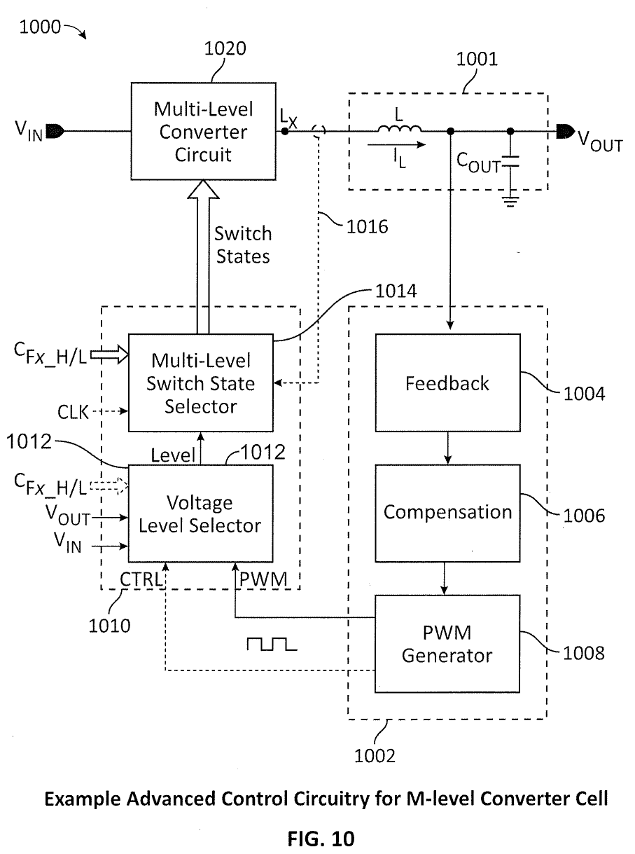

FIG. 10 is a block diagram of one embodiment of advanced control circuitry 1000 for an M-level converter cell 1000 such as the generalized version depicted in FIG. 8B. The M-level converter cell 1020 is shown coupled to an output block 1001 comprising an inductor L and an output capacitor C_{OUT} (conceptually, the inductor L also may be considered as being included within the M-level converter cell 1020). The advanced control circuitry 1000 functions as a control loop coupled to the output of the M-level converter cell 1020 and to switch control inputs of the M-level converter cell 1020. In general, the advanced control circuitry 1000 is configured to monitor the output (e.g., voltage and/or current) of the M-level converter cell 1020 and dynamically generate a set of switch control inputs to the M-level converter cell 1020 that attempt to stabilize the output voltage and/or current at specified values, taking into account variations of V_{IN} and output load. In alternative embodiments, the advanced control circuitry 1000 may be configured to monitor the input of the M-level converter cell 1020 (e.g., voltage and/or current) and/or an internal node of the M-level converter cell 1020 (e.g., the voltage across one or more fly capacitors or the current through one or more power switches). Accordingly, most generally, the advanced control circuitry 1000 may be configured to monitor the voltage and/or current of a node (e.g., input terminal, internal node, or output terminal) of the M-level converter cell 1020. The advanced control circuitry 1000 may be incorporated into, or separate from, the overall controller for a power converter 100 embodying the M-level converter cell 1020.

A first block comprises a feedback controller 1002, which may be a traditional controller such as a fixed frequency voltage mode or current mode controller, a constant-ON-time controller, a hysteretic controller, or any other variant. The feedback controller 1002 is shown as being coupled to V_{OUT} from the M-level converter cell 1020. In alternative embodiments, the feedback controller 1002 may be configured to monitor the input of the M-level converter cell 1020 and/or an internal node of the M-level converter cell 1020. The feedback controller 1002 produces a signal directly or indirectly indicative of the voltage at V_{OUT} that determines in general terms what needs to be done in the multi-level converter cell 1020 to maintain desired values for V_{OUT}: charge, discharge, or tri-state (i.e., open, with no current flow).

In the illustrated example, the feedback controller 1002 includes a feedback circuit 1004, a compensation circuit 1006, and a PWM generator 1008. The feedback circuit 1004 may include, for example, a feedback-loop voltage detector which compares V_{OUT} (or an attenuated version of V_{OUT}) to a reference voltage which represents a desired V_{OUT} target voltage (which may be dynamic) and outputs a control signal to indicate whether V_{OUT} is above or below the target voltage. The feedback-loop voltage detector may be implemented with a comparison device, such as an operational amplifier (op-amp) or transconductance amplifier (gm amplifier).

The compensation circuit 1006 is configured to stabilize the closed-loop response of the feedback controller 1002 by avoiding the unintentional creation of positive feedback, which may cause oscillation, and by controlling overshoot and ringing in the step response of the feedback controller 1002. The compensation circuit 1006 may be implemented in known manner, and may include LC and/or RC circuits.

The PWM generator 1008 generates the actual PWM control signal which ultimately sets the duty cycle of the switches of the multi-level converter cell 1020. In addition, in some embodiments, the PWM generator 1008 may pass on additional optional control signals CTRL indicating, for example, the magnitude of the difference between V_{OUT} and the reference voltage (thus indicating that some levels of the M-level converter cell 1020 should be bypassed to get to higher or lower levels), and the direction of that difference (e.g., whether V_{OUT} is greater than or less than the reference voltage). In other embodiments, the optional control signals CTRL can be derived from the output of the compensation circuit 1006, or from the output of the feedback circuit 1004, or from a separate comparator (not shown) coupled to, for example, V_{OUT}. One purpose of the optional control signals CTRL is for advanced control algorithms, when it may be beneficial to know how far away V_{OUT} is from a target output voltage, thus allowing faster charging of the inductor L if the V_{OUT} is severely under regulated.

A second block comprises a multi-level controller 1010, the primary function of which is to select the switch states that generate a desired V_{OUT} while maintaining a charge-balance state on the fly capacitors within the M-level converter cell 1020 every time an output voltage level is selected, regardless of what switch state or states were used in the past.

The multi-level controller 1010 includes a Voltage Level Selector 1012 which receives the PWM control signal and the additional control signals CTRL if available. In addition, the Voltage Level Selector 1012 may be coupled to V_{OUT} and/or V_{IN}, and, in some embodiments, to the HIGH/LOW status signals, C_{Fx_H/L}, from the voltage detectors coupled to corresponding fly capacitors Cx within the M-level converter cell 1020. A function of the Voltage Level Selector 1012 is to translate the received signals to an output voltage Target Level (e.g., on a cycle-by-cycle basis). The Voltage Level Selector 1012 typically will consider at least V_{OUT} and V_{IN} to determine which Target Level should charge or discharge the output of the M-level converter cell 1020 with a desired rate. For example, in a 6-level converter circuit, the available Target Levels are Level-1 (GND), Level-2 (⅕V_{IN}), Level-3 (⅖V_{IN}), Level-4 (⅗V_{IN}), Level-5 (⅘V_{IN}), and Level-6 (V_{IN}), which may be represented as a count value from 1-6 (or 0-5).

As an example, in a 4-Level converter circuit, if V_{IN}=12V and V_{OUT} nominally should be 3V, then the Voltage Level Selector 1012 may indicate that a Target Level of “2” can be selected, which results in a ⅓V_{IN} voltage level at L_{X} (i.e., 4V). The PWM control signal sets a duty cycle between that Target Level and another Target Level (e.g., GND) so that the average voltage level at L_{X} will be about 3V.

In general, for steady-state operations, the Target Level voltage closest to V_{OUT} that either charges or discharges the inductor L may be selected for simplicity of the selection algorithm. In general, for transient response, a Target Level that is higher (for charging) or lower (for discharging) than the closest Target Level may be selected to quickly charge or discharge the inductor L. The Voltage Level Selector 1012 may be implemented, for example, as a look-up table (LUT) or as comparison circuitry and combinatorial logic or more generalized processor circuitry. In some embodiments, the Voltage Level Selector 1012 can implement advanced methods (described below) that try to speed up charging or discharging based on additional factors, such as inductor voltage drop, load transients, the magnitude of output deviations, and/or external input signals from external sources. The output of the Voltage Level Selector 1012 may include duty cycle information (e.g., derived from the input PWM control signal) as well as switch state.

The output of the Voltage Level Selector 1012 is coupled to a Multi-Level Switch State Selector 1014, which generally would be coupled to the status signals, C_{Fx_H/L}, from the voltage detectors for the fly capacitors Cx. Taking into account the Target Level generated by the Voltage Level Selector 1012, the Multi-Level Switch State Selector 1014 determines a pattern of switch states for the desired output level that generally achieves charge-balancing the fly capacitors Cx. The Multi-Level Switch State Selector 1014 may be implemented, for example, as comparison circuitry and combinatorial logic, as a look-up table (LUT), or as more generalized processor circuitry. The output of the Multi-Level Switch State Selector 1014 is coupled to the switches of the multi-level converter cell 1020 (through appropriate level-shifter circuits and drivers circuits, as may be needed for a particular converter cell) and includes a pattern of switch state settings determined by the Multi-Level Switch State Selector 1014. The pattern of switch state settings selects the configuration of the switches within the multi-level converter cell 1020.

In general (but not always), for PWM-based control systems, the Voltage Level Selector 1012 and the M-level Switch State Selector 1014 only change their states when the PWM signal changes. For example, when the PWM signal goes high, the Voltage Level Selector 1012 selects which level results in charging of the inductor L and the M-level Switch State Selector 1014 sets which version to use of that level. Then when the PWM signal goes low, the Voltage Level Selector 1012 selects which level can discharge the inductor L and the M-level Switch State Selector 1014 sets which version of that level to use. Thus, the Voltage Level Selector 1012 and the M-level Switch State Selector 1014 generally only change states when the PWM signal changes (the PWM signal is in effect their clock signal). However, there may be situations or events where it is desirable for the CTRL signal to change the state of the Voltage Level Selector 1012. Further, there may be situations or events where it is desirable for the C_{Fx_H/L} status signal(s) to cause the M-level Switch State Selector 1014 to select a particular configuration of power switch settings, such as when a severe mid-cycle imbalance occurs. In some embodiments, it may be useful to include a timing function that forces the M-level Switch State Selector 1014 to re-evaluate the optimal version of the state periodically, for example, in order to avoid being “stuck” at one level for a very long time, potentially causing charge imbalances.

One notable benefit of the control circuitry shown in FIG. 10 is that it enables generation of voltages in boundary zones between voltage levels, which represent unattainable output voltages for conventional multi-level DC-to-DC converter circuits.

In alternative unregulated charge-pumps embodiments, the feedback controller 1002 and the Voltage Level Selector 1012 may be omitted, and instead a clock signal CLK may be applied to the M-level Switch State Selector 1014. The M-level Switch State Selector 1014 would generate a pattern of switch state settings that periodically charge balances the fly capacitors Cx regardless of what switch state or states were used in the past (as opposed to cycling through a pre-defined sequency of states). This ensures that if V_{IN} changes or anomalous evens occur, the system generally always seeks charge balance for the fly capacitors Cx.

In some embodiments, the M-level Switch State Selector 1014 may take into account the current I_{L} flowing through the inductor L by way of an optional current-measurement input 1016, which may be implemented in conventional fashion.

In an M-level multi-level converter circuit, the configuration of switches that achieves Level-1 (e.g., GND) or Level-M (e.g., V_{IN}) effectively bypasses the fly capacitors Cx. Conversely, for all intermediate voltage levels, at least one fly capacitor Cx is coupled to V_{OUT} and there are always at least two configurations of switches that can achieve any intermediate voltage level. For any particular intermediate voltage level, at least one configuration of switches results in charging the associated fly capacitor and at least one other configuration of switches results in discharging the associated fly capacitor. One aspect of the present disclosure is the realization that any achievable output voltage V_{OUT} requiring intermediate voltage levels can be attained by dynamically selecting patterns of switch configurations—that is, by selecting switch configurations without regard to or memory of the switch configurations of any previous switching cycle—to select appropriate Levels, and doing so in a way that purposefully selects either charging or discharging switch configurations that also balance charge across the fly capacitors Cx.

Embodiments of the disclosure use the following approach for positive inductor L current (charging V_{OUT}):
(1) a fly capacitor Cx that needs charging will be set to close its charging switch (the outer high-side switch in outer-switch control methods, or the inner low-side switch for inner-switch control methods); and
(2) a fly capacitor Cx that needs discharging will be set to close its discharging switch (the outer low-side switch for outer-switch control methods, or the inner high-side switch for inner-switch control methods).

For negative inductor L current (discharging V_{OUT}), the selection of switches inverts. Accordingly:
(1) a fly capacitor Cx that needs charging will be set to close its charging switch (the outer low-side switch in outer-switch control methods, or the inner high-side switch for inner-switch control methods); and
(2) a fly capacitor Cx that needs discharging will be set to close its discharging switch (the outer high-side switch for outer-switch control methods, or the inner low-side switch for inner-switch control methods).

Note again that whether or not charging actually occurs for a particular fly capacitor Cx generally depends on the switch states for all other fly capacitors. For a fly capacitor C(x) to actually charge or discharge, the next inward (if one exists) fly capacitor C(x−1) (for outer-switch control methods) or the previous outward (if one exists) fly capacitor C(x+1) (for inner-switch control methods) must be set to the opposite state (i.e., discharge or charge) so that a bypass situation does not occur.

For any multi-level converter circuit of order M that can create M voltage levels—i.e., Level-1 (e.g., GND) through Level-M (e.g., V_{IN})—then the following switch count rules apply for any Level-m:
(1) M−m low-side switches must be set to be closed (ON);
(2) m−1 high-side switches must be set to be closed (ON); and
(3) switches that are not required to be ON must be set to be OFF (open).

With these switch count rules in mind, the following generalized capacitor control method applies for each state change of the Multi-Level Switch State Selector 1014:
Step 1) Select a fly capacitor that has not previously been selected;
Step 2) If the voltage of the selected fly capacitor is above its Vtarget and there are remaining (i.e., not been set by this method in this cycle) low-side or high-side switches that can be set to be closed to enable a discharge path for the selected fly capacitor, then set those switches that enable a discharge path for the selected fly capacitor to be closed, decrement one or more appropriate counters (e.g., for the number of low-side switches set to be closed and the number of high-side switches set to be closed), and flag the current fly capacitor as “done” (i.e., as having been selected); otherwise (since the voltage of the selected fly capacitor is below its Vtarget) set the switches that enable a charging path for the selected fly capacitor to be closed and flag the current fly capacitor as “done”;
Step 3) Loop to Step 1 until all fly capacitors have been selected;
Step 4) For the remaining pair of left-over switches, set the high-side switch or the low-side switch to be closed based on the switch count rules and the counter values.

With the above generalized capacitor control method, more specific multi-level charge-balancing control methods can be created. Examples can be found, for example, in U.S. Patent Publication No. 20230148059, which is incorporated by reference herein in its entirety.

Many electronic products, particularly mobile computing and/or communication products and components (e.g., cell phones, notebook computers, ultra-book computers, tablet devices, electronic displays) require multiple voltage levels. For example, radio frequency (RF) transmitter power amplifiers may require relatively high voltages (e.g., 12V or more), whereas logic circuitry may require a low voltage level (e.g., 1-2V). Still other circuitry may require an intermediate voltage level (e.g., 5-10V).

Power converters are often used to generate a lower or higher voltage from a common power source, such as a battery, Universal Serial Bus (USB) or USB-C power sources, or a rectified AC power source that is converted to DC. Some power converters, such as multi-level power converters, employ one or more switched capacitor networks. Some multi-level power converters use capacitors as the primary energy storage elements to transfer power from the input to the output of the circuit. A series of switches, such as transistors used as switches, may be used to place a power converter in different states to charge or discharge capacitors as needed. These charge transfer capacitors are commonly known as “fly capacitors” or “pump capacitors” and may be external components coupled to an integrated circuit embodiment of the switches and associated control circuitry.

### Control of Capacitor Voltage in Multi-Level Converter Circuits

This disclosure recognizes that in some multi-level converter circuits, such as 3-level converter circuit 800 in FIG. 8A, traditional control techniques may result in subharmonic waveforms for current through an output inductor. Such control techniques and associated subharmonic waveforms at an output are also applicable to multi-level converter circuits that do not have an output inductor. In an aspect, subharmonic waveforms at an output of a multi-level converter circuit may be referred to as output subharmonic waveforms or output subharmonics. Larger subharmonic output currents may be associated with higher root-mean-square (RMS) currents, which are generally associated with lower efficiency. For example, traditional control techniques may simply alternate between charge and discharge states at a certain frequency or duty cycle for each state, without regard for fly capacitor voltage, such as fly capacitor C₁ in FIG. 8A. The frequency of switching between charge and discharge states may be selected to maintain an overall average voltage across a fly capacitor without regard to whether the capacitor is occasionally overcharged or undercharged. Such conventional techniques may result in an output current subharmonic whose periodic waveform occurs at half the expected frequency and twice the expected amplitude. Traditional design techniques may select a charge-discharge state switching frequency with an understanding that the system self-balances at all times, which may not always be the case.

Disclosed herein are new techniques for controlling multi-level power converters. The techniques mitigate the potential for subharmonic current waveforms (e.g., output subharmonic current waveforms), leading to increased efficiency. The voltage across a capacitor is monitored, and a charge or discharge state may be selected based on whether the monitored voltage is greater than or less than a target voltage. Control of the capacitor voltage may be performed without regard to a set frequency of selecting a charge-discharge sequence but rather may be performed based on measurements of the capacitor voltage. Such techniques may avoid significantly over or under-charging a fly capacitor.

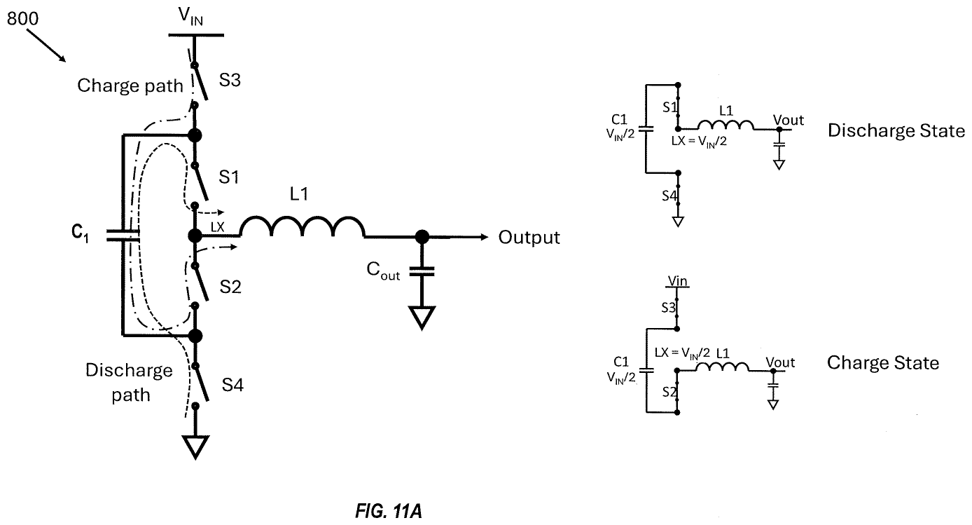

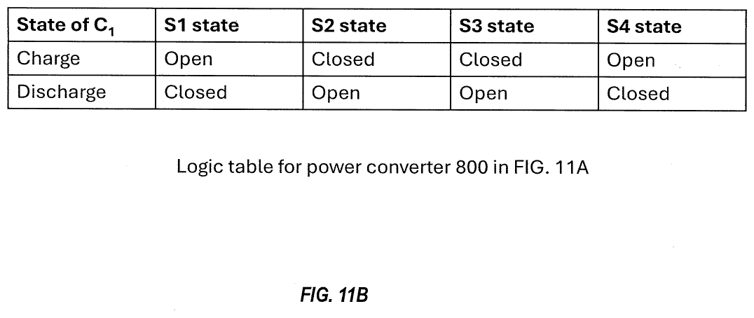

FIG. 11A is a circuit diagram illustrating the charge and discharge states of the example 3-level converter circuit 800, in accordance with one or more embodiments of the present disclosure. The switch states of the converter circuit 800 are further explained with respect to the logic table for power converter 800, presented in FIG. 11B. There are two switch states that result in the voltage level at node LX being equal to about V_{IN}/2. One state herein is referred to as a “charge state,” and in this state the capacitor C₁ is being charged as shown in FIG. 11A. Further, one state herein is referred to as a “discharge state,” and in this state the capacitor C₁ is being discharged as shown in FIG. 11A. In the charge state, switches S2 and S3 are set in a closed state, and switches S1 and S4 are set in an open state. In the discharge state, switches S2 and S3 are set in an open state, and switches S1 and S4 are set in a closed state.

The switches S1-S4 may be implemented using FETs, as understood in the art. For example, the switches S1-S4 may be implemented as FETs, where the on/off (closed/open) state of each FET is controlled by a gate voltage. A target voltage across the capacitor C₁ may be about V_{IN}/2.

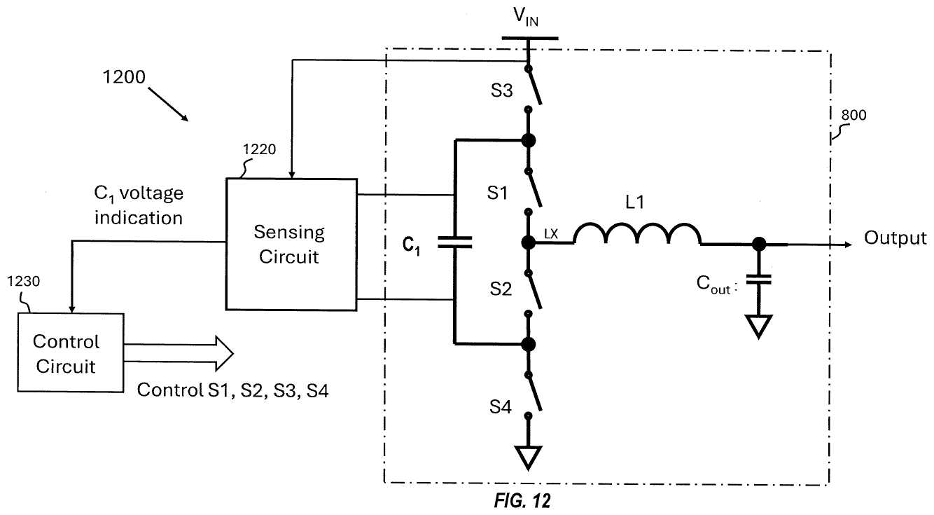

FIG. 12 illustrates an example multi-level power converter circuit 800 within a system 1200, according to some aspects of the disclosure. As shown, the system 1200 may include the multi-level power converter circuit 800, a sensing circuit 1220, and a control circuit 1230. As discussed previously, the multi-level power converter circuit 800 includes series-connected switches S1-S4 and capacitor C₁ as shown.

The sensing circuit 1220 is configured to provide an indication of voltage across capacitor C₁ as compared to a fraction of V_{IN}, which can be used in a control loop to ensure that the voltage across C₁ remains in a specified range. The voltage indication produced by sensing circuit 1220 is labeled as “C1 voltage indication.” These voltage indications are provided to a control circuit 1230, which may also be referred to as a state selection circuit. The control circuit receives a C₁ voltage indication as an input, and selects the states of switches S1-S4 based on the voltage indication, as well as potentially other inputs (not shown). The control circuit 1230 produces output signals that control the state of each switch S1-S4. For example, there may be one control signal for each of four switches S1-S4, with a control signal being connected to a gate of a switch Sn to control whether the switch is open or closed. As discussed earlier, switches S1-S4 may be implemented using gate-controlled FETs. The states of switches S1-S4 may be selected periodically, such as during some multiple of clock cycles (e.g., every clock cycle, every two clock cycles, etc.), or may be selected based on the voltage across fly capacitor C₁ (e.g., as measured by sensing circuit 1220). A system clock (not shown) may generate a clock signal having a clock frequency. The clock frequency may be a number of MHz (e.g., 1 MHz, 2 MHz, etc.), for example. Further detail is provided below.

The output of power converter circuit 800 may be connected to a load (not shown). Additionally, the system 1200 may be implemented as part of an integrated circuit.

In some embodiments, by sampling the voltage across C₁ to determine whether to enter the charge state or the discharge state, reverse current flow (e.g., also referred to as back charging) from an output to the power supply V_{IN} may be minimized relative to when the power converter simply alternates between charge and discharge states at a certain frequency or duty cycle. In FIG. 12, the reverse current flow is from the Output through the inductor to the power supply V_{IN}. In this regard, when the power converter simply alternates between charge and discharge states at a certain frequency or duty cycle, current may be delivered bidirectionally.

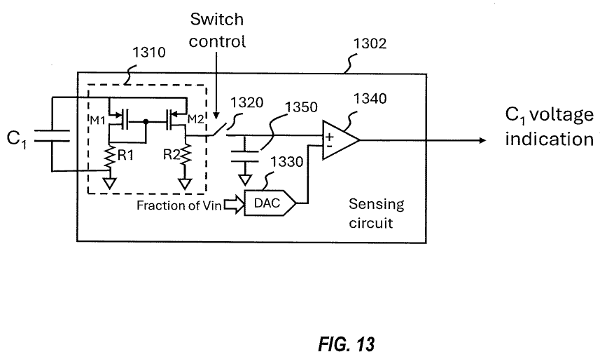

FIG. 13 illustrates an example embodiment of a sensing circuit 1302, according to some aspects of the disclosure. Sensing circuit 1220 in FIG. 12 may each be implemented as sensing circuit 1302, for example. The sensing circuit 1302 includes a current mirror 1310. The current mirror 1310 includes MOSFETs M1 and M2 and resistors R1 and R2 connected as shown. The sensing circuit 1302 uses current mirror 1310 to sense the differential voltage across a capacitor Cn, which may be a fly capacitor. The current mirror 1310 includes at least two tunable gain factors. One is gain factor M2/M1 and another is gain factor R2/R1. The factor M2/M1 represents a ratio of a size of M2 divided by a size of M1, and the factor R2/R1 represents a ratio of the resistance of R2 divided by the resistance of R1.

A switch 1320 is connected to an output of the current mirror 1310. To blank transition losses during switching of power states in a multi-level power converter, switch 1320 remains open until the transient noise from a power state transition dies down. A switch control signal is used to open and close switch 1320 as shown, and the switch control signal may delay closing the switch after a power state transition using a delay that is a function of the transition losses of the power converter, such as the power converter in FIG. 12. When switch 1320 is closed the output current charges the holding capacitor 1350 to track the average voltage. A comparator 1340 compares a sample voltage at one input to a voltage reference target to determine if the capacitor Cn is adequately charged. For example, if Cn represents C1 in system 1300, the target voltage may be Vin/2. A digital to analog converter (DAC) 1330 may receive a digitized voltage target, such as Vin/2, and convert the voltage target to analog for use in comparator 1340. Alternatively, the DAC 1330 may employ a variable gain and may scale a digitized value of Vin by an appropriate fraction (e.g., ½). The capacitor voltage indication at the output of comparator 1340 may represent a difference between the capacitor voltage (as represented by the sample voltage) and the target voltage.

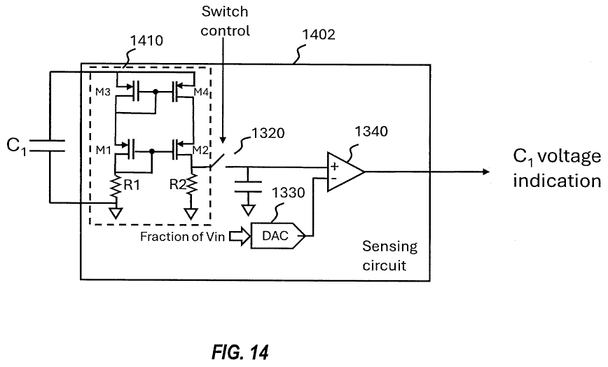

FIG. 14 illustrates another example of a sensing circuit 1402, according to some aspects of the disclosure. The sensing circuit 1402 is essentially the same as the sensing circuit 1302, except for the form of the current mirror 1410. The current mirror 1410 is configured as a cascode current mirror, which has a benefit of making the gain factor M2/M1 more stable. M3 and M4 are MOSFETs.

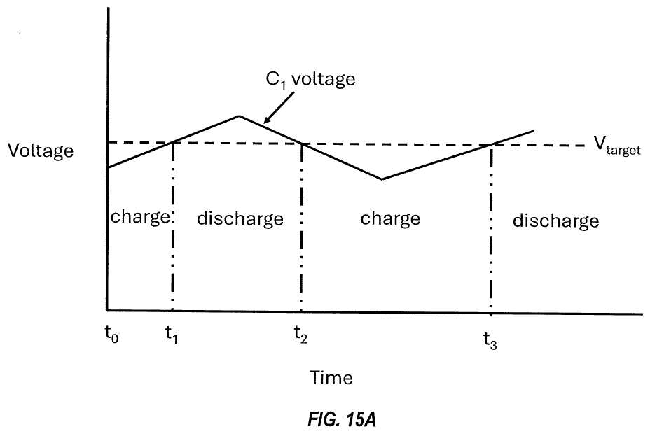

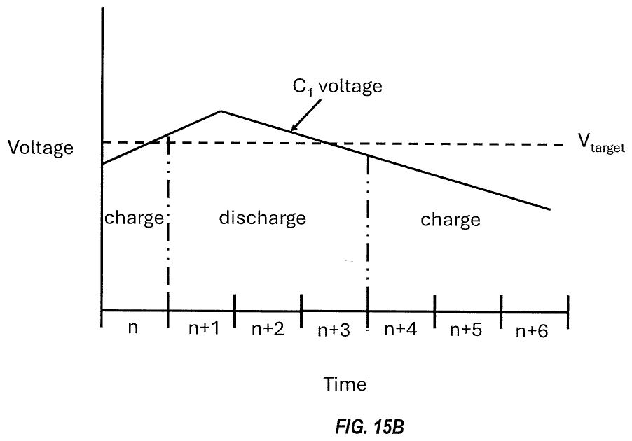

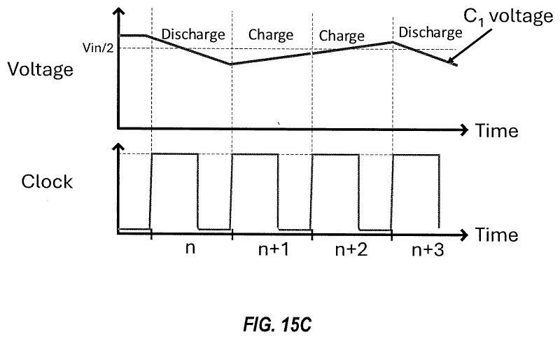

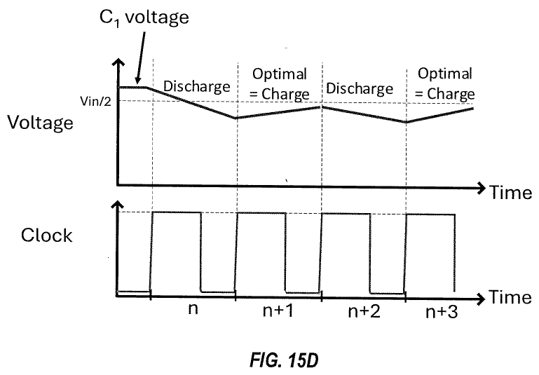

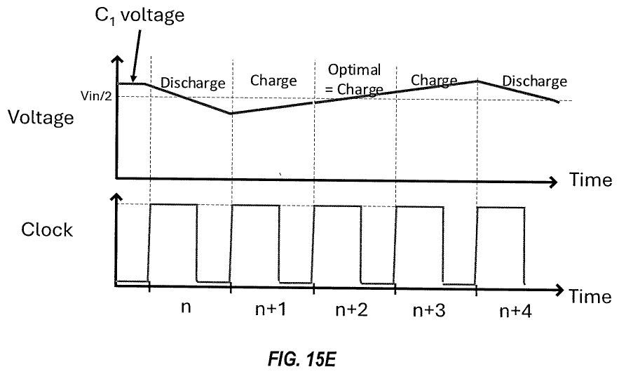

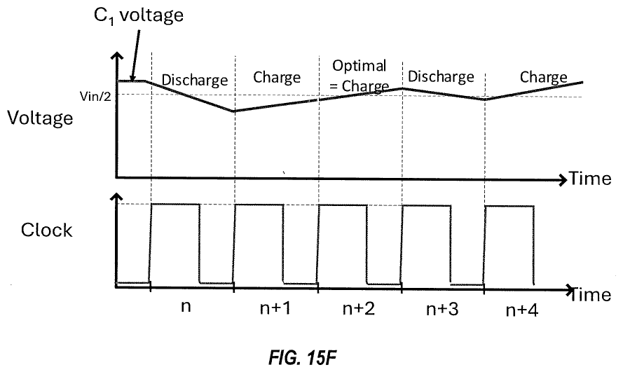

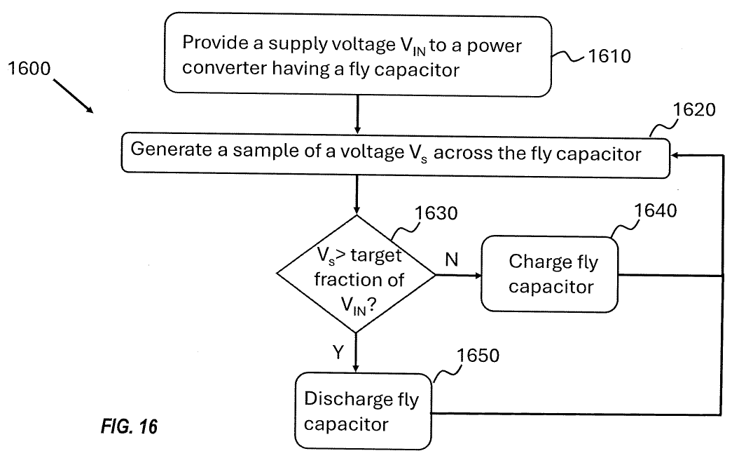

FIG. 15A illustrates an example timing diagram for controlling a multi-state power converter, according to some aspects of the disclosure; and FIG. 16 illustrates an example of a method 1600 of controlling a multi-state power converter, according to some aspects of the disclosure. The method 1600 may be explained with reference to FIG. 15A. In step 1610, a supply voltage V_{IN} is supplied to a power converter having a fly capacitor, such as power converter circuit 800 having fly capacitor C₁. The input voltage may be 5 V, 10 V, or any other DC voltage. Next in step 1620, a sample of a voltage across a fly capacitor Vs is generated. For example, step 1620 may be performed in sensing circuits 1302 or 1402 in FIGS. 13 and 14, respectively, to generate a voltage sample. In step 1630, the sample voltage Vs is compared to a target fraction of the supply voltage V_{IN}, and a decision is made whether to charge (step 1640) or discharge (step 1650) the fly capacitor. The steps 1630, 1640, and 1650 may be performed in a control circuit, such as control circuit 1230. If sample voltage exceeds the target voltage, a power converter, such as power converter 800, may be placed in a discharge state (e.g., according to the logic table in FIG. 11B). If sample voltage is less than the target voltage, the power converter may be placed in a charge state (e.g., according to the logic table in FIG. 11B). A comparator, such as comparator 1340, may generate a voltage signal that is positive or negative depending on a difference between the sample voltage and the target voltage.

The steps 1620-1650 may be performed with some periodicity, such as every clock cycle. For example, the steps 1620-1650 may be performed at or near the end of each clock cycle such that the charge or discharge state of a power converter may be established for the next clock cycle. Further, although the method 1600 has been described with respect to the control of a three-level converter, the method 1600 may also be applied to the control of a four-level converter circuit, such as the example four-level converter circuit presented in FIG. 8B. A sensing circuit, such as any of the sensing circuits presented herein, may be coupled to one of the fly capacitors C1 or C2 and a charge or discharge state of the fly capacitor may be set according to a sensed voltage across the fly capacitor relative to a target voltage.

The method 1600 may be performed such that when the measured voltage across a fly capacitor is less than a target voltage (e.g., denoted as Vtarget in FIG. 15A), the power converter is placed in a charge state, and when the measured voltage across a fly capacitor is greater than the target voltage, the power converter is placed in a discharge state. For example, when method 1600 is employed, the durations of the charge and discharge states may look like the states presented in FIG. 15A, according to one embodiment. During time intervals t₀ to t₁ and t₂ to t₃, the power converter is placed in a charge state; and during the time intervales t₁ to t₂ and a time greater than t₃, the power converter is placed in a discharge state.

The time periods for the charge and discharge states may not be predetermined and may be based only on the measured voltage across a fly capacitor and not, as examples, on a condition of a load connected to the output or any previous state of the power converter during any previous clock cycle (i.e., in some embodiments, the selection of charge and discharge states has no memory of previous states of the power converter circuit or load condition). Each of the time intervals illustrated in FIG. 15A may span one or more clock cycles. For example, each time interval may span numerous clock cycles, depending only on the fly capacitor C₁ voltage.

The control of the state of a power converter may thus yield any sequence of charge and discharge states, such as charge-charge-discharge in three consecutive clock cycles, or discharge-discharge-charge, or charge-charge-charge, or discharge-discharge-discharge, as examples. For example, an example timing diagram is presented in FIG. 15B where time is shown in units of clock cycles and a decision about charge/discharge state is made at the beginning of each clock cycle. As shown, the sequence of states for seven consecutive clock cycles is charge-discharge-discharge-discharge-charge-charge-charge.

In some aspects, in a given clock cycle, the sample voltage may be generated and the decision about charge/discharge state for a next clock cycle may be made. For example, in an n^{th} clock cycle, the sample voltage may be generated and the decision to select the charge state for an (n+1)^{th} clock cycle may be made. As one example, the sample voltage may be generated by latching the voltage of the fly capacitor toward an end of a present clock cycle (e.g., around 10 ns before a rising edge of a next clock cycle in some cases) and a state decision for the next clock cycle made in the present clock cycle based on the sample voltage. As another example, the sample voltage is not a directly measured/latched voltage and may instead be a voltage estimation/projection of fly capacitor voltage toward the end of the present clock cycle.

As discussed previously, the method 1600 may mitigate the occurrence of subharmonic currents appearing in an output inductor, such as inductor L1 in FIG. 11A. It may be possible to also mitigate the occurrence of subharmonic currents through deliberate selection of values for various passive components in the power converter circuit 800, such as capacitors C₁ and/or Cₒᵤₜ and/or inductor L1, as well as the system clock frequency. For example, if the input capacitance is greater than the fly capacitance, the subharmonics can be reduced. As Vin capacitance approaches fly capacitance, every additional capacitance on Vin may have less and less impact on the sub harmonic.

FIG. 15C illustrates an example timing diagram for controlling a multi-state power converter, according to some aspects of the disclosure. In FIG. 15C, to determine whether to select the charge state or the discharge state for each clock cycle associated with a clock signal (e.g., a system clock signal), a sample of the fly capacitor C₁ voltage is generated in step 1620. In step 1630, the sample voltage is compared to a target voltage of V_{IN}/2, and a decision is made to pick/select the discharge state (step 1650) to discharge the fly capacitor C₁ if the sample voltage is above V_{IN}/2 or otherwise pick/select the charge state (step 1640) to charge the fly capacitor C₁. For an n^{th} clock cycle, a sample of the fly capacitor C₁ voltage is above V_{IN}/2 and the discharge state is selected. For an (n+1)^{th} clock cycle, a sample of the fly capacitor C₁ voltage is not above V_{IN}/2 and the charge state is selected. For an (n+2)^{th} clock cycle, a sample of the fly capacitor C₁ voltage is not above V_{IN}/2 and the charge state is selected. For an (n+3)^{th} clock cycle, a sample of the fly capacitor C₁ voltage is above V_{IN}/2 and the discharge state is selected. In an aspect, a sequence associated with the n^{th} through (n+3)^{th} clock cycles may be represented as discharge-charge-charge-discharge or DCCD, with each selected state of the sequence being based on the capacitor state (e.g., whether the fly capacitor C₁ voltage is above or not above V_{IN}/2).

In some embodiments, for a given time interval, a state (e.g., charge state or discharge state) that is selected based on performing of the steps 1620 and 1630 may be referred to as an adaptive state or an optimal state. In this regard, in FIGS. 15A through 15C, each state is an adaptive state. In some embodiments, charge states and discharge states of a power converter may be established according to a predetermined sequence of charge states, discharge states, and adaptive states. In this regard, a sequence may provide temporal positioning of each adaptive state and each non-adaptive state. In an aspect, non-adaptive states may refer to predetermined states and states determined based on one or more prior states, as further described herein. The adaptive states may be interspersed in the sequence of states to break up the subharmonic waveforms/oscillations. In some aspects, no more than two consecutive states (e.g., in two consecutive clock cycles) may be adaptive states. In some aspects, no more than three consecutive states may be adaptive states.

FIG. 15D illustrates an example timing diagram for controlling a multi-state power converter, according to some aspects of the disclosure. In FIG. 15D, the discharge state is selected during each odd clock cycle and an adaptive state is selected during each even clock cycle. In an aspect, such a sequence of states may generally be represented by DoDoDo . . . , where D denotes the discharge state and o denotes an adaptive state or optimal state. In this regard, the method 1600 may be performed to determine the adaptive state during the even clock cycles, whereas the discharge state is selected during the odd clock cycles without regard for fly capacitor voltage. To determine whether to select the charge state or the discharge state for each even clock cycle, a sample of the fly capacitor C₁ voltage is generated in step 1620. In step 1630, the sample voltage is compared to a target voltage of V_{IN}/2, and a decision is made to pick/select the discharge state (step 1650) to discharge the fly capacitor C₁ if the sample voltage is above V_{IN}/2 or otherwise pick/select the charge state (step 1640) to charge the fly capacitor C₁.

In FIG. 15D, n is an odd integer. For an n^{th} clock cycle, the discharge state is selected without regard to the fly capacitor voltage. For an (n+1)^{th} clock cycle, a sample of the fly capacitor C₁ voltage is not above V_{IN}/2 and the charge state is selected. For an (n+2)^{th} clock cycle, the discharge state is selected without regard to the fly capacitor voltage. For an (n+3)^{th} clock cycle, a sample of the fly capacitor C₁ voltage is not above V_{IN}/2 and the charge state is selected. In some cases, in a given clock cycle (e.g., toward an end of the given clock cycle), the sample voltage may be generated and the decision about charge/discharge state for a next clock cycle may be made. For example, in an n^{th} clock cycle, the sample voltage may be generated and the decision to select the charge state for the (n+1)^{th} clock cycle may be made. A sequence for FIG. 15D may be written as DCDC.

Since every second clock cycle is associated with the discharge state, a given sequence implementable according to DoDoDo . . . may allow additional discharge cycles to be selected if necessary (e.g., based on fly capacitor voltage measurements) and thus there can be no more than 50% charge cycles. In an aspect, the sequence DoDoDo . . . may be utilized when a system is imbalanced favoring more discharge cycles. Alternatively, a sequence of CoCoCo . . . (e.g., rather than DoDoDo . . . ) in which each odd clock cycle is associated with a charge state and each even clock cycle is associated with an adaptive state may be utilized if imbalance is expected to bleed a capacitor.

FIG. 15E illustrates an example timing diagram for controlling a multi-state power converter, according to some aspects of the disclosure. In FIG. 15E, an adaptive state is selected for every third cycle whereas other cycles follow a C-D sequence. In an aspect, a sequence may generally be represented by DCoCDoDCoCDoDCo . . . , where D denotes the discharge state, C denotes the charge state, o denotes an adaptive state or optimal state. In this regard, the method 1600 may be performed to determine the adaptive state during every third clock cycle, whereas the remaining states are predetermined. To determine whether to select the charge state or the discharge state for every third clock cycle, a sample of the fly capacitor C₁ voltage is generated in step 1620. In step 1630, the sample voltage is compared to a target voltage of V_{IN}/2, and a decision is made to pick/select the discharge state (step 1650) to discharge the fly capacitor C₁ if the sample voltage is above V_{IN}/2 or otherwise pick/select the charge state (step 1640) to charge the fly capacitor C₁.

For an n^{th} clock cycle, the discharge state is selected without regard to the fly capacitor voltage. For an (n+1)^{th} clock cycle, the charge state is selected without regard to the fly capacitor voltage. For an (n+2)^{th} clock cycle, a sample of the fly capacitor C₁ voltage is not above V_{IN}/2 and the charge state is selected. For an (n+3)^{th} clock cycle, the charge state is selected without regard to the fly capacitor voltage. For an (n+4)^{th} clock cycle, the discharge state is selected without regard to the fly capacitor voltage. In some cases, in a given clock cycle (e.g., toward an end of the given clock cycle), the sample voltage may be generated and the decision about charge/discharge state for a next clock cycle may be made. For example, in an (n+1)^{th} clock cycle, the sample voltage may be generated and the decision to select the charge state for the (n+2)^{th} clock cycle may be made. A sequence for FIG. 15E may be written as DCCCD. The sequence DCoCDoDCoCDoDCo . . . may allow selection of extra charge or discharge cycles. In some cases, such a sequence may be associated with created subharmonics that have a lower frequency than other sequences, such as the sequences associated with FIGS. 15C and 15D.

FIG. 15F illustrates an example timing diagram for controlling a multi-state power converter, according to some aspects of the disclosure. In FIG. 15F, an adaptive state is selected for every third cycle and, if the third cycle creates two consecutive charge cycles or two consecutive discharge cycles, the CD sequence is flipped to prevent three consecutive cycles in sequence (e.g., three consecutive discharge cycles or three consecutive charge cycles). In this regard, the method 1600 may be performed to determine the adaptive state during every third clock cycle. To determine whether to select the charge state or the discharge state for every third clock cycle, a sample of the fly capacitor C₁ voltage is generated in step 1620. In step 1630, the sample voltage is compared to a target voltage of V_{IN}/2, and a decision is made to pick/select the discharge state (step 1650) to discharge the fly capacitor C₁ if the sample voltage is above V_{IN}/2 or otherwise pick/select the charge state (step 1640) to charge the fly capacitor C₁.

In FIG. 15F, the first two clock cycles have a D-C sequence. For an n^{th} clock cycle, the discharge state is selected without regard to the fly capacitor voltage. For an (n+1)^{th} clock cycle, the charge state is selected without regard to the fly capacitor voltage. For an (n+2)^{th} clock cycle, a sample of the fly capacitor C₁ voltage is not above V_{IN}/2 and the charge state is selected. For an (n+3)^{th} clock cycle and an (n+4)^{th} clock cycle, the D-C sequence of the n^{th} and (n+1)^{th} clock cycle can be repeated (e.g., does not need to be flipped) since the D-C sequence does not cause three consecutive discharge stages. As such, the sequence associated with FIG. 15F has states following the adaptive state being selected based on one or more prior states. It is noted that the states of the n^{th} and (n+1)^{th} clock cycles may themselves have been selected based on states in clock cycles prior to the n^{th} clock cycle. In some cases, in a given clock cycle (e.g., toward an end of the given clock cycle), the sample voltage may be generated and the decision about charge/discharge state for a next clock cycle may be made. For example, in an (n+1)^{th} clock cycle, the sample voltage may be generated and the decision to select the charge state for the (n+2)^{th} clock cycle may be made. In an aspect, non-adaptive states may refer to predetermined states and states determined based on one or more prior states.

It is noted that although FIGS. 15B through 15F are described in relation to periodicity defined by a clock cycle in which a duration of each state (e.g., charge state, discharge state, adaptive state) in a sequence is substantially the same, a duration of each state (e.g., charge state, discharge state, adaptive state) in a sequence need not be the same in other implementations.

A sequence of states used for operating a multi-level converter circuit is generally application dependent. In this regard, temporal positioning of adaptive states and non-adaptive states and a ratio of a number of adaptive states to a number of non-adaptive states in a sequence may be application dependent. In some embodiments, adaptive states may be temporally positioned to minimize output subharmonic waveforms and non-adaptive states may be temporally positioned to minimize input subharmonic waveforms. In some cases, adaptive states may help minimize reverse current flow. For example, a sequence in which an adaptive state is selected for every clock cycle (e.g., by performing the method 1600 for every clock cycle) may be utilized in applications that desire minimized reverse current flow and/or minimized output subharmonic waveforms.

In some systems/applications, back driving (e.g., bidirectionality, reverse current flow) may be undesirable. As one example, a wireless charger system having a charge pump for charging a communication device (e.g., a phone) may not be appropriate for back driving. The communication device may communicate back and forth with a base station according to a communication protocol that modulates a voltage. As such, when back driving (e.g., reverse current flow, bidirectionality) of the charge pump is not prevented, such communications may be associated with drops in an input voltage, which may cause reverse current flow. When the reverse current flow increases, the charge pump tries to maintain the input voltage (e.g., prevent the input voltage from dropping) and thus acts against the communications between the communication device and the base station when the communication device is being charged. This acting against the communications corrupts the communication protocol and prevents communication using the communication protocol. In such a wireless charger system, a sequence in which an adaptive state is selected for operation of the charge pump in every clock cycle may prevent the back driving.

In some systems/applications, back driving (e.g., bidirectionality, reverse current flow) may be utilized/leveraged. As one example, a communication device (e.g., a phone) may leverage reverse charging to wireless charge audio devices (e.g., ear buds). A forward current flow from a charge pump to the communication device may be used to charge the communication device. A reverse current flow from the communication device may be used to charge the audio devices using the communication device.

In some embodiments, a sequence having all adaptive states or a high number of consecutive adaptive states may break up the output subharmonic waveforms as provided above, but may be associated with a higher input ripple (e.g., also referred to as a higher input subharmonic) of low frequency if an input capacitance is smaller relative to the fly capacitance. This input capacitance may be in series with the fly capacitance. For example, if the fly capacitor is charged for a long time (e.g., many consecutive charge states), whether as predetermined charge states and/or selected states, the input does not see an input for a long duration until a large current pulse(s) (e.g., bursty current pulses) is seen by the input. Such higher input ripple may be mitigated if the input capacitance can be increased (e.g., with or without adjustment to the sequence of states). In various applications, such as in wireless communications applications, the input ripple is as low as feasible and at higher frequencies.

Thus, in some embodiments, sequences may define combinations of adaptive states with other states (e.g., predetermined states, states determined based on one or more prior states, etc.) may mitigate output subharmonic waveforms (e.g., using adaptive states) as well as input subharmonic waveforms. In some cases, reverse current flow may be minimized through such sequences.

Further aspects of the present disclosure include the following:

Aspect 1 includes A method comprising: providing a supply voltage to a power converter, wherein the power converter comprises a fly capacitor, wherein the power converter is selectively configurable in one of a plurality of states comprising a charge state of the fly capacitor and a discharge state of the fly capacitor, and wherein a target voltage across the fly capacitor is a fraction of the supply voltage; generating a voltage sample of a voltage across the fly capacitor; and selecting between the charge state and the discharge state based on the voltage sample by selecting the charge state when the target voltage exceeds the voltage sample and the discharge state when voltage sample exceeds the target voltage.

Aspect 2 includes the method of aspect 1, wherein the generating and the selecting are repeated for each of a series of clock cycles from a system clock.

Aspect 3 includes the method of aspect 2, wherein the power converter is a three-level converter comprising four switches connected in series, and wherein the charge state and the discharge state correspond to respective states of the four switches.

Aspect 4 includes the method of aspect 3, further comprising: computing a difference between the voltage sample and the target voltage using a sensing circuit, wherein the generating the voltage sample is performed using the sensing circuit, and wherein the difference is used to indicate when the target voltage exceeds the voltage sample or when the voltage sample exceeds the target voltage.

Aspect 5 includes the method of aspect 4, further comprising sending the difference to a control circuit that selects the charge state when the difference is positive and selects the discharge state when the difference is negative.

Aspect 6 includes the method of aspect 5, wherein the difference is computed in a first clock cycle and the power converter operates in a selected state as the charge state or the discharge state in a clock cycle that immediately follows the first clock cycle based on the difference.

Aspect 7 includes the method of aspect 6, further comprising: supplying power to a load using the power converter, wherein the selecting does not depend on a condition of the load.

Aspect 8 includes the method of aspect 6, wherein the selected state in the clock cycle that immediately follows the first clock cycle is determined without regard for the states of the four switches in the first clock cycle.

Aspect 9 includes a system comprising: a power converter comprising a fly capacitor, wherein the power converter is selectively configurable in one of a plurality of states comprising a charge state of the fly capacitor and a discharge state of the fly capacitor, and wherein the power converter is configured to connect to a supply voltage terminal; and a sensing circuit configured to compare a measured voltage across the fly capacitor and a target fraction of a voltage supplied to the supply voltage terminal to generate a comparison value, wherein the power converter is set to the charge state when the comparison value indicates that the measured voltage exceeds the target fraction and is set to the discharge state when the comparison value indicates that the measured voltage is less than the target fraction.

Aspect 10 includes the system of aspect 9, wherein the sensing circuit is further configured to connect to the fly capacitor, wherein the sensing circuit comprises: a sampling circuit configured to generate the measured voltage as a sample; and a comparator configured to compare the sample with the target fraction to generate the comparison value.

Aspect 11 includes the system of aspect 10, wherein the power converter is a three-level converter comprising four switches connected in series, and wherein the charge state and the discharge state correspond to respective states of the four switches.

Aspect 12 includes the system of aspect 9, further comprising: a system clock configured to generate a plurality of clock cycles of a specified frequency; and a control circuit configured to control a state of the power converter based on the comparison value, wherein the comparison value is generated in a first clock cycle of the plurality of clock cycles, and wherein the control circuit is configured to set the charge state or the discharge state for a subsequent clock cycle of the plurality of clock cycles based on the comparison value.

Aspect 13 includes the system of aspect 12, wherein the state of the power converter is selected in each clock cycle of the plurality of clock cycles without regard for the state of the power converter in previous clock cycles.

Aspect 14 includes the system of aspect 11, further comprising a control circuit configured to control a state of the power converter based on the comparison value.

Aspect 15 includes the system of aspect 14, wherein the control circuit is configured to: receive the comparison value; select the state of the power converter as a selected state; and control the power converter such that the power converter switches to the selected state.

Aspect 16 includes the system of aspect 9, further comprising an inductor coupled to the power converter, wherein the power converter is configured to supply power to a load via the inductor.

Aspect 17 includes an integrated circuit comprising: a switchable power conversion network configured to connect to a voltage supply terminal and a capacitor, wherein the switchable power conversion network is switchable among a charging state and a discharging state, wherein in the charging state the switchable power conversion network is set to charge the capacitor, wherein in the discharging state the switchable power conversion network is set discharge the capacitor, wherein the switchable power conversion network is configured to be set to the discharge state when a measured voltage across the capacitor exceeds a target value and set to the charge state otherwise.

Aspect 18 includes the integrated circuit of aspect 17, further comprising a sensing circuit configured to compare the measured voltage across the capacitor and the target value to generate a comparison value, and wherein the target value is a target fraction of a voltage supplied to the supply voltage terminal.

Aspect 19 includes the integrated circuit of aspect 18, further comprising a control circuit configured to: receive the comparison value; and select a state of the switchable power conversion network as the discharge state when the comparison value indicates that the measured voltage across the capacitor exceeds the target value and select the state of the switchable power conversion network as the charge state otherwise.

Aspect 20 includes the integrated circuit of aspect 19, wherein the comparison value is generated in a first clock cycle of a plurality of clock cycles, and wherein the control circuit is configured to select one of the charge state or the discharge state for a subsequent clock cycle of the plurality of clock cycles based on the comparison value.

Aspect 21 includes the integrated circuit of aspect 17, wherein a state of the switchable power conversion network is configured to be repeatedly selected in each clock cycle of a plurality of clock cycles based on comparing respective measured voltages across the capacitor to the target value in one-to-one correspondence between a selection and a comparison.

### Programmable Embodiments

Some or all aspects of the disclosure, such as the Multi-Level Switch State Selector 1014 of FIG. 10 or the control circuit 1230 of FIG. 12, may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code may be applied to input data to perform the functions described in this disclosure and generate output information. The output information may be applied to one or more output devices in known fashion.

Each such computer program may be implemented in any desired computer language (including machine, assembly, or high-level procedural, logical, or object-oriented programming languages) to communicate with a computer system, and may be implemented in a distributed manner in which different parts of the computation specified by the software are performed by different computers or processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently or permanently), the storage media or device being readable by a general or special purpose programmable computer or processor for configuring and operating the computer or processor when the storage media or device is read by the computer or processor to perform the procedures described above. The inventive system may also be considered to be implemented as a non-transitory computer-readable storage medium, configured with a computer program, where the storage medium so configured causes a computer or processor to operate in a specific or predefined manner to perform the functions described in this disclosure.

### Fabrication Technologies & Options

The term “MOSFET”, as used in this disclosure, includes any field effect transistor (FET) having an insulated gate whose voltage determines the conductivity of the transistor, and encompasses insulated gates having a metal or metal-like, insulator, and/or semiconductor structure. The terms “metal” or “metal-like” include at least one electrically conductive material (such as aluminum, copper, or other metal, or highly doped polysilicon, graphene, or other electrical conductor), “insulator” includes at least one insulating material (such as silicon oxide or other dielectric material), and “semiconductor” includes at least one semiconductor material.

As used in this disclosure, the term “radio frequency” (RF) refers to a rate of oscillation in the range of about 3 kHz to about 300 GHz. This term also includes the frequencies used in wireless communication systems. An RF frequency may be the frequency of an electromagnetic wave or of an alternating voltage or current in a circuit.

With respect to the figures referenced in this disclosure, the dimensions for the various elements are not to scale; some dimensions have been greatly exaggerated vertically and/or horizontally for clarity or emphasis. In addition, references to orientations and directions (e.g., “top”, “bottom”, “above”, “below”, “lateral”, “vertical”, “horizontal”, etc.) are relative to the example drawings, and not necessarily absolute orientations or directions.

Various embodiments of the invention can be implemented to meet a wide variety of specifications. Unless otherwise noted above, selection of suitable component values is a matter of design choice. Various embodiments of the invention may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies such as bipolar, BiCMOS, LDMOS, BCD, GaAs HBT, GaN HEMT, GaAs pHEMT, and MESFET technologies. However, embodiments of the invention are particularly useful when fabricated using an SOI or SOS based process, or when fabricated with processes having similar characteristics. Fabrication in CMOS using SOI or SOS processes enables circuits with low power consumption, the ability to withstand high power signals during operation due to FET stacking, good linearity, and high frequency operation (i.e., radio frequencies up to and exceeding 300 GHz). Monolithic IC implementation is particularly useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present invention may be used alone or in combination with other components, circuits, and devices. Embodiments of the present invention may be fabricated as integrated circuits (ICs), which may be encased in IC packages and/or in modules for ease of handling, manufacture, and/or improved performance. In particular, IC embodiments of this invention are often used in modules in which one or more of such ICs are combined with other circuit blocks (e.g., filters, amplifiers, passive components, and possibly additional ICs) into one package. The ICs and/or modules are then typically combined with other components, often on a printed circuit board, to form part of an end product such as a cellular telephone, laptop computer, or electronic tablet, or to form a higher-level module which may be used in a wide variety of products, such as vehicles, test equipment, medical devices, etc. Through various configurations of modules and assemblies, such ICs typically enable a mode of communication, often wireless communication.

A number of embodiments of the disclosure have been described. It is to be understood that various modifications may be made without departing from the spirit and scope of the disclosure. For example, some of the steps described above may be order independent, and thus can be performed in an order different from that described. Further, some of the steps described above may be optional. Various activities described with respect to the methods identified above can be executed in repetitive, serial, and/or parallel fashion.

It is to be understood that the foregoing description is intended to illustrate and not to limit the scope of the disclosure, which is defined by the scope of the following claims, and that other embodiments are within the scope of the claims. In particular, the scope of the disclosure includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. A method comprising:
providing a supply voltage to a power converter, wherein the power converter comprises a fly capacitor, wherein the power converter is selectively configurable in one of a plurality of states comprising a charge state of the fly capacitor and a discharge state of the fly capacitor, and wherein a target voltage across the fly capacitor is a fraction of the supply voltage;
generating a voltage sample of a voltage across the fly capacitor; and
selecting between the charge state and the discharge state based on the voltage sample by selecting the charge state when the target voltage exceeds the voltage sample and selecting the discharge state when the voltage sample exceeds the target voltage.

2. The method of claim 1, wherein the generating and the selecting are repeated for each of a series of clock cycles from a system clock.

3. The method of claim 2, wherein the power converter is a three-level converter comprising four switches connected in series, and wherein the charge state and the discharge state correspond to respective states of the four switches.

4. The method of claim 3, further comprising:
computing a difference between the voltage sample and the target voltage using a sensing circuit, wherein the generating the voltage sample is performed using the sensing circuit, and wherein the difference is used to indicate when the target voltage exceeds the voltage sample or when the voltage sample exceeds the target voltage.

5. The method of claim 4, further comprising sending the difference to a control circuit that selects the charge state when the difference is positive and selects the discharge state when the difference is negative.

6. The method of claim 5, wherein the difference is computed in a first clock cycle and the power converter operates in a selected state as the charge state or the discharge state in a clock cycle that immediately follows the first clock cycle based on the difference.

7. The method of claim 6, further comprising:
supplying power to a load using the power converter, wherein the selecting does not depend on a condition of the load.

8. The method of claim 6, wherein the selected state in the clock cycle that immediately follows the first clock cycle is determined without regard for the states of the four switches in the first clock cycle.

9. The method of claim 1, wherein the selecting is performed in a first clock cycle and the power converter operates in a selected state as the charge state or the discharge state in a second clock cycle that immediately follows the first clock cycle, wherein the power converter operates in a first predetermined state in the first clock cycle, and wherein the first predetermined state is one of the charge state or the discharge state.

10. The method of claim 9, wherein the power converter operates in a second predetermined state in a third clock cycle that immediately follows the second clock cycle, and wherein the second predetermined state is one of the charge state or the discharge state.

11. The method of claim 1, wherein the selecting is performed in a first clock cycle and the power converter operates in a first selected state as the charge state or the discharge state in a second clock cycle that immediately follows the first clock cycle, the method further comprising:
selecting, as a second selected state, between the charge state and the discharge state based on whether the first selected state is the charge state or the discharge state and whether an operation state of the power converter in the first clock cycle is the charge state or the discharge state, wherein the power converter operates in the operation state in the first clock cycle, and wherein the power converter operates in the second selected state in a third clock cycle that immediately follows the second clock cycle.

12. A system comprising:
a power converter comprising a fly capacitor, wherein the power converter is selectively configurable in one of a plurality of states comprising a charge state of the fly capacitor and a discharge state of the fly capacitor, and wherein the power converter is configured to connect to a supply voltage terminal; and
a sensing circuit configured to compare a measured voltage across the fly capacitor and a target fraction of a voltage supplied to the supply voltage terminal to generate a comparison value,
wherein the power converter is set to the charge state when the comparison value indicates that the measured voltage is less than the target fraction and is set to the discharge state when the comparison value indicates that the measured voltage exceeds the target fraction.

13. The system of claim 12, wherein the sensing circuit is further configured to connect to the fly capacitor, wherein the sensing circuit comprises:
a sampling circuit configured to generate the measured voltage as a sample; and
a comparator configured to compare the sample with the target fraction to generate the comparison value.

14. The system of claim 13, wherein the power converter is a three-level converter comprising four switches connected in series, and wherein the charge state and the discharge state correspond to respective states of the four switches.

15. The system of claim 12, further comprising:
a system clock configured to generate a plurality of clock cycles of a specified frequency; and
a control circuit configured to control a state of the power converter based on the comparison value,
wherein the comparison value is generated in a first clock cycle of the plurality of clock cycles, and wherein the control circuit is configured to set the charge state or the discharge state for a subsequent clock cycle of the plurality of clock cycles based on the comparison value.

16. The system of claim 15, wherein the state of the power converter is selected in each clock cycle of the plurality of clock cycles without regard for the state of the power converter in previous clock cycles.

17. The system of claim 14, further comprising a control circuit configured to control a state of the power converter based on the comparison value.

18. The system of claim 17, wherein the control circuit is configured to:
receive the comparison value;
select the state of the power converter as a first selected state; and
control the power converter such that the power converter switches to the first selected state.

19. The system of claim 18, wherein:
the control circuit is configured to select the first selected state in a first clock cycle;
the power converter is configured to:
operate in a first predetermined state in the first clock cycle, wherein the first predetermined state is one of the charge state or the discharge state; and
operate in the first selected state in a second clock cycle that immediately follows the first clock cycle.

20. The system of claim 19, wherein the power converter is configured to operate in a second predetermined state in a third clock cycle that immediately follows the second clock cycle, and wherein the second predetermined state is one of the charge state or the discharge state.

21. The system of claim 18, wherein:
the control circuit is configured to:
select the first selected state in a first clock cycle; and
select, as a second selected state, between the charge state and the discharge state based on whether the first selected state is the charge state or the discharge state and whether an operation state of the power converter in the first clock cycle is the charge state or the discharge state; and
the power converter is configured to:
operate in the operation state in the first clock cycle;
operate in the first selected state in a second clock cycle that immediately follows the first clock cycle; and
operate in the second selected state in a third clock cycle that immediately follows the second clock cycle.

22. The system of claim 12, further comprising an inductor coupled to the power converter, wherein the power converter is configured to supply power to a load via the inductor.

23. An integrated circuit comprising:
a switchable power conversion network configured to connect to a voltage supply terminal and a capacitor,
wherein the switchable power conversion network is switchable among a charging state and a discharging state,
wherein in the charging state the switchable power conversion network is set to charge the capacitor,
wherein in the discharging state the switchable power conversion network is set discharge the capacitor,
wherein the switchable power conversion network is configured to be set to the discharge state when a measured voltage across the capacitor exceeds a target value and set to the charge state otherwise.

24. The integrated circuit of claim 23, further comprising a sensing circuit configured to compare the measured voltage across the capacitor and the target value to generate a comparison value, and wherein the target value is a target fraction of a voltage supplied to the supply voltage terminal.

25. The integrated circuit of claim 24, further comprising a control circuit configured to:
receive the comparison value; and
select a first selected state of the switchable power conversion network as the discharge state when the comparison value indicates that the measured voltage across the capacitor exceeds the target value and select the state of the switchable power conversion network as the charge state otherwise.

26. The integrated circuit of claim 25, wherein the comparison value is generated in a first clock cycle of a plurality of clock cycles, and wherein the control circuit is configured to select one of the charge state or the discharge state for a subsequent clock cycle of the plurality of clock cycles based on the comparison value.

27. The integrated circuit of claim 26, wherein:
the control circuit is configured to select the first selected state in the first clock cycle based on the comparison value; and
the switchable power conversion network is configured to:
operate in a first predetermined state in the first clock cycle, wherein the first predetermined state is one of the charge state or the discharge state; and
operate in the first selected state in a second clock cycle of the plurality of clock cycles that immediately follows the first clock cycle.

28. The integrated circuit of claim 27, wherein the switchable power conversion network is configured to operate in a second predetermined state in a third clock cycle of the plurality of clock cycles that immediately follows the second clock cycle, and wherein the second predetermined state is one of the charge state or the discharge state.

29. The integrated circuit of claim 27, wherein:
the control circuit is configured to select, as a second selected state, between the charge state and the discharge state based on whether the first selected state is the charge state or the discharge state and whether an operation state of the switchable power conversion network in the first clock cycle is the charge state or the discharge state; and
the switchable power conversion network is configured to:
operate in the operation state in the first clock cycle;
operate in the first selected state in a second clock cycle of the plurality of clock cycles that immediately follows the first clock cycle; and
operate in the second selected state in a third clock cycle of the plurality of clock cycles that immediately follows the second clock cycle.

30. The integrated circuit of claim 23, wherein a state of the switchable power conversion network is configured to be repeatedly selected in each clock cycle of a plurality of clock cycles based on comparing respective measured voltages across the capacitor to the target value in one-to-one correspondence between a selection and a comparison.
